(19) United States
(12) Patent Application Publication
(10) Pub. No.: US 2019/0018408 A1
(43) Pub. Date: Jan. 17, 2019

(54) SYSTEMS AND METHODS FOR VERIFYING INTEGRITY OF A SENSING SYSTEM

(71) Applicant: QUALCOMM Incorporated, San Diego, CA (US)

(72) Inventors: Rahul Gulati, San Diego, CA (US); Mainak Biswas, Fremont, CA (US); Pranjal Bhuyan, San Diego, CA (US); Anshuman Saxena, San Diego, CA (US)

(21) Appl. No.: 15/648,347

(22) Filed: Jul. 12, 2017

(51) Int. Cl. G05D 1/00; G05D 1/02; G08G 1/0962; G08G 1/0968; G07C 5/00

(52) U.S. Cl. CPC G05D 1/0055; G05D 1/0248; G07C 5/006; G08G 1/09623; G08G 1/096805; G05D 1/0257

(57) ABSTRACT

Devices and methods are disclosed for verifying the integrity of a sensing system. In one aspect, a vehicle includes an integrated circuit configured to support a message-based protocol between the integrated circuit and a sensor device associated with the vehicle, and send a sensor capability safety support message, as part of the message-based protocol, to determine one or more capabilities of the sensor device. The integrated circuit is also configured to receive, in response to the sensor capability safety support message, identification data corresponding to the sensor device, from the sensor device. The memory is configured to store a plurality of request data corresponding to a plurality of fields supported by the message-based protocol and associated with the integrated circuit and the sensor device capabilities, and store the response, including the identification data, from the sensor device.

### TECHNICAL FIELD

The systems and methods disclosed herein are directed to sensing systems for use in safety applications, and, more particularly, for ensuring system operational integrity of sensing systems for use in safety applications.

### BACKGROUND

Driver assistance systems, also referred to as Advanced Driver Assistance Systems (ADAS), have been introduced to assist drivers while operating automotive vehicles. These systems have been developed to automate or enhance the safety of these vehicles, for example, by reducing human error by alerting a driver to a potential problem in the environment surrounding the vehicle. Such systems include adaptive cruise control, collision avoidance, parking assist, pedestrian detection, automated braking, traffic warnings, driver alertness detection systems, etc.

Driver assistance systems are required to meet the functional safety specifications of International Standard 26262 (ISO 26262). ISO 26262 is an international standard for functional safety of electrical or electronic systems in automotive vehicles and defines functional safety requirements for these systems throughout their lifecycle used for safety critical application, such as, for example, ADAS. For example, one requirement of ISO 26262 is to ensure integrity of the various components (e.g., hardware and software) of the electronic systems involved in safety critical applications.

To support the functional safety requirements of ISO 26262, a comprehensive self-test methodology is needed to guarantee safe operation and/or safe operational degradation of hardware and software components of electrical systems used in safety applications throughout operation in the field and its lifecycle. Software based self-tests have been proposed as an effective alternative to hardware based self-tests in order to eliminate or reduce the die area needed to support the testing in the underlying ADAS hardware.

### SUMMARY

A summary of sample aspects of the disclosure follows. For convenience, one or more aspects of the disclosure may be referred to herein simply as “some aspects.”

Methods, systems, and apparatuses or devices being disclosed herein each have several aspects, no single one of which is solely responsible for its desirable attributes. Without limiting the scope of this disclosure, for example, as expressed by the claims which follow, its more prominent features will now be discussed briefly.

One aspect of the present disclosure provides a vehicle. The vehicle may include an integrated circuit that includes a processor that may be configured to support a message-based protocol between the integrated circuit and one or more sensor devices associated with the vehicle. The integrated circuit may also be configured to send a sensor capability safety support message, which is part of the message-based protocol, to determine one or more sensor device capabilities of the one or more sensor devices. In response to the sensor capability safety support message, the processor may be configured to receive identification data corresponding to the one or more sensor devices, from the one or more sensor device. The vehicle may also include a memory configured to store multiple request data corresponding to multiple fields supported by the message-based protocol and associated with the integrated circuit and the one or more sensor devices capabilities, and store the response, including the identification data, from the one or more sensor devices.

In various embodiments, the integrated circuit may be configured to periodically receive first baseline vehicle safety data associated with the identification data corresponding to the one or more sensor devices based on the message-based protocol. The periodically received first baseline vehicle safety data may be compared with second baseline vehicle safety data from the memory. The integrated circuit may also be configured to identify a failure if the periodically received first baseline vehicle safety data does not match the second baseline vehicle safety data from the memory.

Another aspect of the present disclosure provides a method. The method may include sending a sensor capability safety support message to determine one or more sensor device capabilities of the one or more sensor devices. The sensor capability safety support message may be part of a message-based protocol between an integrated circuit and one or more sensor devices associated with a vehicle. In response to the sensor capability safety support message, the method may also include receiving identification data corresponding to the one or more sensor devices, from the one or more sensor devices and storing multiple request data corresponding with multiple fields supported by the message-based protocol associated with the integrated circuit and the one or more sensor devices capabilities. The method may also include storing the response, including the identification data, from the one or more sensor devices.

Another aspect of the present disclosure provides a system for sensing an environment surrounding a vehicle. The system may include a source component that includes a processor configured to support a message-based protocol between the source component and a target component associated with the vehicle. The source component may also be configured to send a capability safety support message, which is part of the message-based protocol, to determine one or more capabilities of the target component, and receive, in response to the capability safety support message, identification data corresponding to the target component, from the target component. The system may also include a memory configured to store multiple request data corresponding to multiple fields supported by the message-based protocol and associated with the source component and the one or more capabilities of the target component, and store the response, including the identification data, from the target component.

Another aspect of the present disclosure provides a non-transitory computer readable medium comprising instructions that when executed cause a processor to perform a method. The method may include sending a capability safety support message to determine one or more capabilities of at least one target component. The capability safety support message may be part of a message-based protocol between at least one source component and the at least one target component. The method may also include receiving, in response to the capability safety support message, identification data corresponding to the at least one target component, from the at least one target component and storing multiple request data corresponding with multiple fields supported by the message-based protocol associated with the at least one source component and the one or more capabilities of the at least one target component. The method may further include storing the response, including the identification data, from the at least one target component.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIG. 1 depicts an example automotive vehicle comprising multiple automotive safety systems.

FIG. 2A depicts a schematic block diagram of an example automotive safety system.

FIG. 2B schematically illustrates an example automotive safety system including a sensor device and an integrated circuit.

FIG. 3 illustrates a flowchart depicting an example method of configuring an automotive safety system.

FIG. 4 illustrates a flowchart depicting another example method of configuring an automotive safety system.

FIGS. 5A-5C illustrate flowcharts depicting example methods of operating an automotive safety system.

FIGS. 6A and 6B illustrate flowcharts depicting a method for implementing an automotive safety system

FIG. 7 schematically illustrates an embodiment of the automotive safety system of FIGS. 2A and 2B configured to verify compliance with safety requirements.

FIGS. 8A and 8B schematically illustrate an example methodology for calibrating components of the automotive safety system of FIG. 2A and 2B.

FIGS. 9A and 9B illustrates an example message flow of a message-base protocol in an automotive safety system.

FIGS. 10A-10F illustrate examples of packet frame formats included in messages of the message-based protocol of FIGS. 9A and 9B.

FIG. 11 depicts a schematic block diagram illustrating an example sensor device of the automotive safety system of FIG. 7.

FIG. 12 depicts a schematic block diagram illustrating an example integrated circuit of the automotive safety system of FIG. 7.

### DETAILED DESCRIPTION

In the following description, specific details are given to provide a thorough understanding of the examples. However, it will be understood that the examples described herein may be practiced without these specific details. For example, electrical components/devices may be shown in block diagrams so not to obscure the examples in unnecessary detail. In other instances, such components, other structures, and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed either in parallel or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It should be noted that the term “functional safety applications,” or variations thereof, may refer to, for example, parts of a system or the use of such parts as described herein that depend on the system operating correctly in response to received inputs. For example, in a sensor-based ADAS, correct operation may be dependent upon properly receiving and processing sensor data representative of the environment around the ADAS (or vehicle thereon). In some implementations, the sensor-based ADAS may be an image-based ADAS where correct operation may be dependent upon properly receiving and processing image frames representative of the environment around the ADAS (or vehicle thereon). As used herein, “functional safety” may refer to the absence of an unreasonable risk due to hazards caused by errors or malfunctions in the systems as described in this application. As used herein, the term “hazard,” or variations thereof, may refer to, for example, a potential source of harm to a user of a system caused by, for example, a fault, error, or malfunction of the electronic system.

As used herein the term “faults,” “operational faults,” or variations thereof may refer to, for example, an abnormal condition of a component of the system that cause the system or component to fail. For example, a fault in an automotive safety system implemented as an image-based system may be a frozen video stream during forward or rear view camera applications. Faults may be classified based on their duration. For example, “permanent faults” may refer to faults that exist indefinitely if no correction action is performed. Such faults may be residual design or manufacturing faults. “Intermittent faults” may refer to faults that appear, disappear, and reappear repeatedly. In some embodiments, when such faults are present, the system may operate correctly the majority of the time, but fail under atypical operating conditions. “Transient faults” may refer to faults that appear and disappear quickly and are not correlated with other faults. Such faults may be induced by random environmental disturbances. Embodiments disclosed in the present application are configured to ensure integrity of the system regardless of the faults present. The presence of any fault may produce an error or malfunction in the operation of the imaging system. As used herein the term “error” may refer to a variation or discrepancy between a processed data value and a true or expected value. As used herein the term “malfunction” may refer to an error or unintended behavior of a component of the system due to one or more faults as described above.

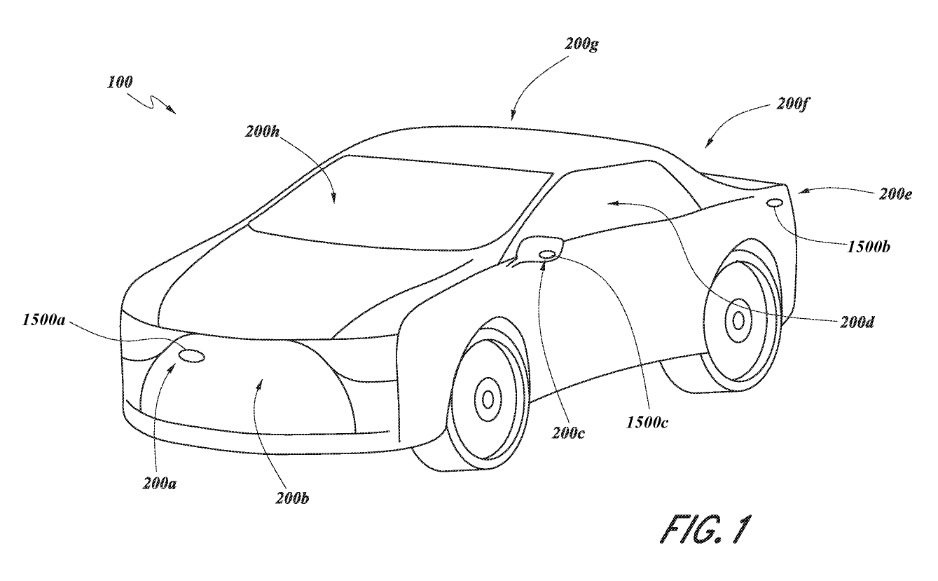

FIG. 1 depicts an example vehicle 100 comprising a plurality of automotive safety systems 200a-200h (collectively hereinafter “200”). The automotive safety systems 200 may be used as part of an ADAS in the vehicle 100. For example, each automotive safety system 200, or the combination of one or more automotive safety systems 200, may be used to detect and analyze the environment around the vehicle 100 (e.g., as a surround view system). Such systems may include, but are not limited to, rear view automotive safety systems, front collision warning systems, traffic sign recognition systems, parking assistance systems, instrument cluster display providing information to the driver or subsystems of the vehicle, etc. The vehicle 100 may be configured to be operated by a driver (e.g., by a steering wheel, accelerator, and decelerator, among other controls and inputs). In some embodiments, the vehicle 100 may be semi-autonomous, such that the vehicle 100 is configured to at least partially control itself without driver input. In another embodiment, the vehicle 100 may be configured to autonomously drive itself.

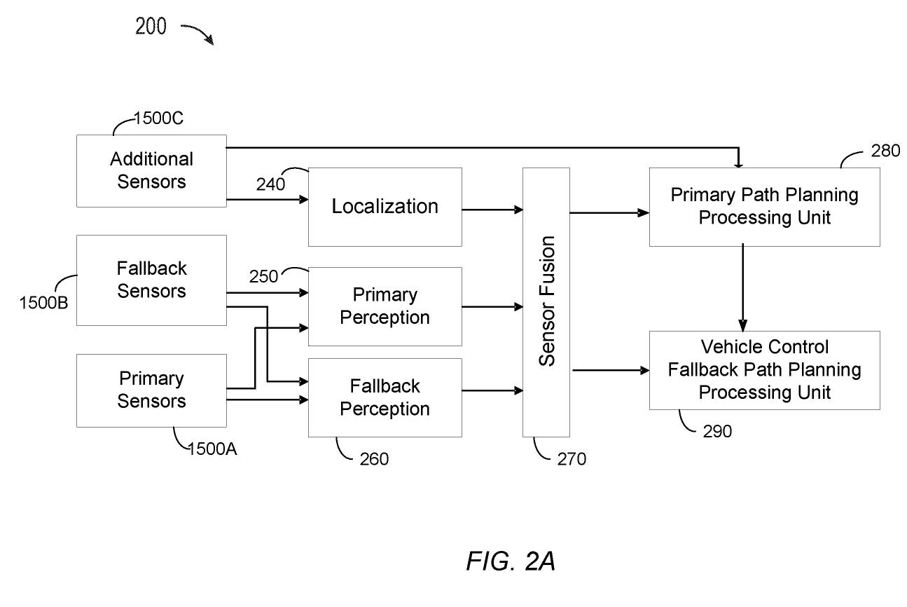

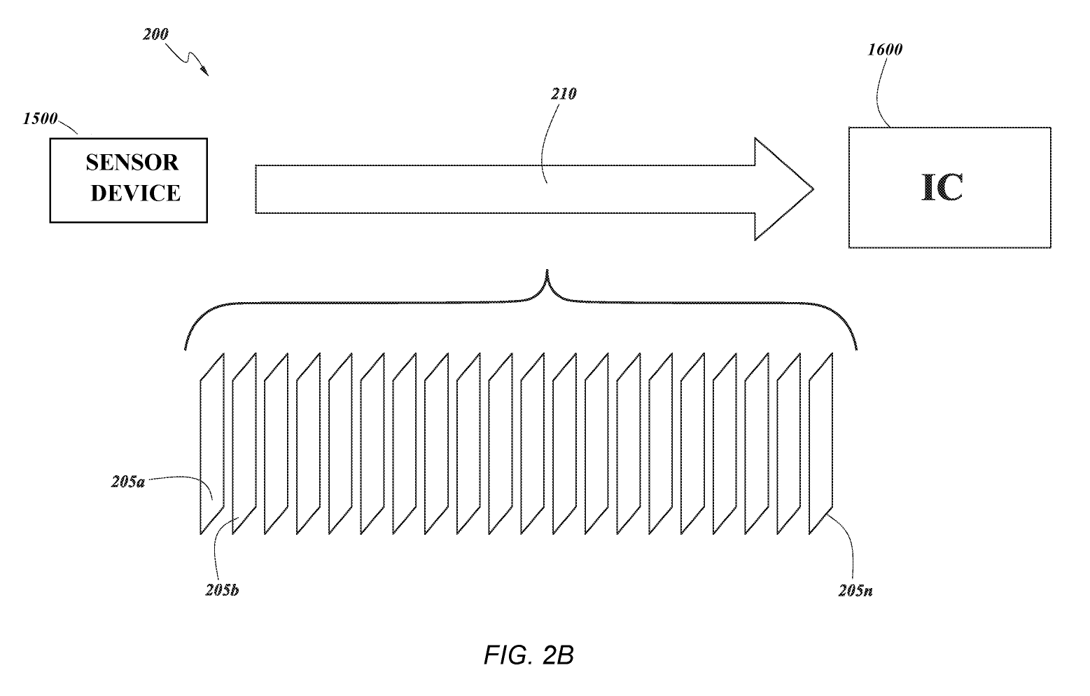

Each automotive safety system 200 may include a sensing system comprising one or more corresponding sensor devices (e.g., sensor device 1500a corresponding to automotive safety system 200a) and an integrated circuit (not shown), as will be described in connection to FIGS. 2A and 2B. It should be noted that the term integrated circuit as used herein may also be referred to as a subsystem of the automotive safety system. The sensor device 1500 may act as an input sensor that captures sensor data of the environment. Such sensor devices 1500 may be image-based sensor devices configured to capture image data. In other embodiments, alone or in combination, the sensors device 1500 may be acoustic-based sensors, motion-based sensors, pressure-based sensors, etc.

For example, the sensor device 1500 may be an imaging device configured as an input sensor that captures image data of the environment within the field of view of that sensor device. The image data may be representative of one or more image frames of a, for example, video stream that may be used by one or more ADAS or surround view systems to assist the drive. For example, sensor device 1500a may capture image data indicative of the environment in front of the vehicle 100. The image data may be transmitted to one or more integrated circuits configured to execute image signal processing and process the image data for use in one or more ADASs. Thus, sensor device 1500a may be an input sensor for front collision warning systems, traffic sign recognition systems, parking assistance systems, etc. Similarly, sensor device 1500e may capture image data from behind the vehicle 100. Thus, sensor device 1500b may be used as an input sensor for rear collision warning systems, rear parking assistance systems, etc. In some embodiments, sensor devices 1500a and 1500b may be input sensors for the same ADAS, e.g., parking assistance systems, surround view systems, etc. While, the forgoing description relates to specific sensor devices, it should be appreciated that any sensor device 1500 may be used alone or in combination with other sensor devices 1500 as input sensors for ADASs. Furthermore, while FIG. 1 depicts example locations for each automotive safety system 200, it is noted that the embodiments described herein are not so limited, and that the vehicle 100 may include automotive safety systems positioned anywhere throughout the vehicle 100. Furthermore, the vehicle 100 may include multiple sensor devices 1500 in communication with a single integrated circuit or multiple integrated circuits.

In some embodiments, the senor device 1500 may be an object detection system configured to determine range, angle, and/or velocity of objects surrounding the vehicle 100. For example, one or more sensor devices 1500 may be a radio detecting and ranging (RADAR) system configured to emit radio waves for use in detecting objects around the vehicle. For example, a RADAR system may be configured to detect acoustic waves by a direct propagation method or a frequency modulated continuous wave (FMCW) method. In another embodiment, alone or in combination, one or more sensor device 1500 may be a light imaging, detection, and ranging (LIDAR) or laser imaging, detection, and ranging (LADAR) system configured to emit light (e.g., broad band or narrow band light) for use in detecting objects around the vehicle. In both examples, the sensor device 1500 may emit the corresponding radio waves or light and receive the radio waves or light reflected back from the surrounding environment to detect objects therein.

In some implementations, an ADAS utilizing images from an automotive safety system 200 (also referred to herein as “image-based ADAS”) may need to satisfy the functional safety requirements defined in ISO 26262 for road vehicles. Similarly, non-image-based ADAS systems may need to satisfy functional safety requirements as defined for each ADAS system, which may be the same or different than those for the image-based ADAS. As described above, ISO 26262 defines functional safety for automotive vehicles that applies throughout the lifecycle of the electronic systems and electronic safety related systems. ISO 26262 is a risk-based safety standard that qualitatively assesses hazardous operational situations and defines safety measurements to avoid or control errors and malfunctions in the systems, detect or control hardware malfunctions, or mitigate the effects of either.

ISO 26262 provides an automotive-specific, risk-based approach for classifying risk, referred to as Automotive Safety Integrity Levels (“ASIL”). The ASIL is determined by analyzing the risk of a potential hazard based on the severity, exposure, and controllability of the hazard during operation of the vehicle. There are four ASILs: ASIL A, ASIL B, ASIL C, and ASIL D. ASIL D may be indicative of the highest level of hazard reduction required to prevent a specific hazard, and ASIL A the lowest. Accordingly, ASIL D may be indicative of the safety requirement, for example, the relatively most stringent verification of integrity.

The ASIL may be representative of a classification of safety goals as well as validation and confirmation methodologies required by ISO 26262 to ensure the safety goals are satisfied. In one implementation, one such classification is a Fault Tolerant Time Interval (FTTI). The FTTI is of an amount of time in which a fault may be present in the electronic systems or electronic safety related systems of the automobile before a hazard occurs or safety is compromised. ISO 26262 defines different FTTIs for safety applications based, at least in part, on the ASIL. For example, an FTTI of 70 milliseconds may be associated with ASIL D, while an FTTI of 300 milliseconds may be associated with an ASIL B.

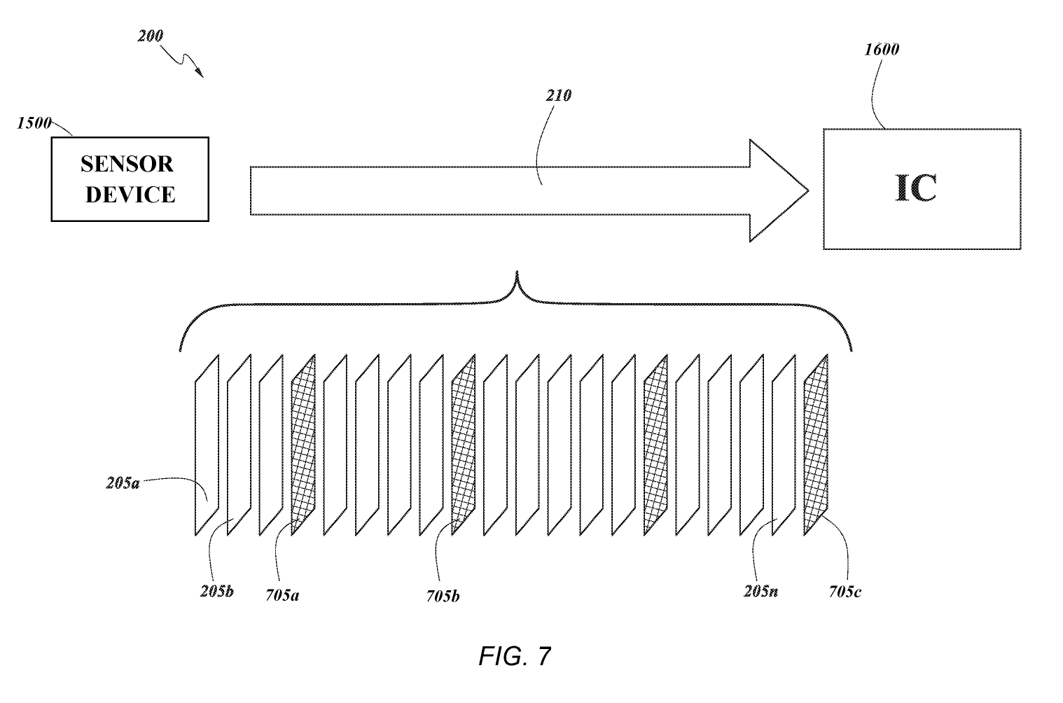

FIGS. 2A and 2B depict schematic block diagrams of example configurations of the automotive safety system 200. FIG. 2 illustrates an example data flow path from the sensor devices 1500 to a vehicle control unit 280 and/or 290. The automotive safety system 200 comprises a set of components, including a plurality of sensor device (e.g., sensor device 1500A-C) that transmit data to a plurality of processing units 240, 250, 260, 270, 280, and 290 of an integrated circuit (e.g., integrated circuit 1600 of FIG. 7). As described in connection to the following figures, the sensor device 1500 may be directly or indirectly coupled to one or more processors of the integrated circuit 1600. The automotive safety system 200 may be configured to utilize data captured by the sensor devices 1500 and process the data via the various processing units as inputs for front or rear collision warning systems, rear parking assistance systems, etc. as described above.

FIG. 2A depicts a primary flow path and a fallback or secondary flow path. In some embodiments, the sensor device 1500A may be designated a “primary sensor device.” As used herein, “primary sensor device” may refer to one or more sensors that operate as the primary source for input data of a corresponding ADAS system. The sensor device 1500B may be designated a “fallback sensor device.” As used herein, a “fallback sensor device” may refer to one or more sensors configured to operate as back up or provide redundancy of the primary sensor devices. In one example, the primary sensor devices 1500A may comprise front facing cameras and/or side RADAR systems configured to detect objects in front the vehicle 100, while the fallback sensor devices 1500B may comprise side cameras, LIDAR systems, and a front RADAR system. It will be appreciated that a primary sensor device for a given automotive safety system may also be configured as a fallback sensor device for another automotive safety system, and vice versa.

The primary sensor device 1500A may be configured to transmit data to a primary perception unit 250. The primary perception unit 250 be connected to a memory storing instructions, that when executed, configure the primary perception unit 250 to detect objects in the environment based on the data received from the primary sensor device 1500A. In some embodiments, the primary perception unit 250 may also be configured to generate a warning based on the detected objects. As illustrated in FIG. 2A, the primary perception unit 250 may be configured to receive data from the primary sensor device 1500A and/or the fallback sensor device 1500B, e.g., when operating as a primary sensor device for another ADAS system.

The fallback sensor device 1500B may be configured to transmit data to a fallback perception unit 260. The fallback perception unit 260 be connected to a memory storing instructions, that when executed, configure the fallback perception unit 260 to detect objects in the environment based on the data received from the primary sensor device 1500B. In some embodiments, the fallback perception unit 260 may also be configured to generate a warning based on the detected objects. As illustrated in FIG. 2A, the fallback perception unit 260 may be configured to receive data from the fallback sensor device 1500B and/or the primary sensor device 1500A, e.g., when operating as a fallback sensor device for another ADAS system.

The primary and fallback perception units 250 and 260 may be configured to transmit detections and/or warnings to a sensor fusion processing unit 270. The sensor fusion processing unit 270 may be configured to combine the detections and outputs from the primary and fallback perception units 250 and 260 for use by the ADAS to assist drivers while operating the vehicle 100. In some embodiments, the sensor fusion processing unit 270 may stitch detection results from the multiple sensor devices into a single representation and/or data indicative of the environment around the vehicle.

The data may then be transmitted to a vehicle control primary path planning processing unit 280. The primary path planning processing unit 280 may be configured to operate the ADAS in accordance with the designed functionality based on the received data. For example, in an adaptive cruise control system, the primary sensor device 1500A may transmit data to the primary perception unit 250 which detects another vehicle in front of the vehicle 100. The primary path planning processing unit 280 may also be considered a vehicle behavior planning processing unit for determining vehicle behavior pursuant to designed specifications. This detection is then transmitted to the primary path planning processing unit 280 which determines to reduce the speed of the vehicle 100 via the adaptive cruise control system. Other configurations are possible.

As will be described below in connection to FIG. 2B, the automotive safety system 200 may be configured to identify a failure in one or more of the sensor devices 1500. In a situation where the failure is in a primary sensor device 1500A, the automotive safety system 200 may determine to fallback on to the fallback sensor device 1500B and fallback perception unit 260. As described above, the fallback perception unit 260 transmits detections and/or warnings to the sensor fusion processing unit 270. The sensor fusion processing unit 270 may be configured to transmit data to a vehicle control fallback path planning processing unit 290, which may include data from primary and/or fallback sensors. In some embodiments, the primary path planning processing unit 280 may be configured to switch the designation of the primary sensor device 1500A to a fallback sensor device, based on the identified failure. The designation of the fallback sensor device 1500B may also be switched to primary sensor device. Thus, the primary path planning processing unit 280 may utilize data from the switched fallback sensor device 1500B (e.g., new primary sensor device) for normal operation. For example, in the adaptive cruise control system example above, a failure in the primary sensor device 1500A causes the designation of the fallback sensor device 1500B to switch, and the adaptive cruise control system may operate as designed.

In some embodiments, the primary path planning processing unit 280 and/or the fallback path planning processing unit 290 may generate a warning that is presented to the driver of the vehicle 100. The warning may notify the driver of the detected fault such that the driver may adjusted his/her operation of the vehicle accordingly.

In another implementation, the fallback path planning processing unit 290 may be configured to determine a fallback or secondary vehicle control based on an identified failure in the primary sensor device 1500A. The fallback vehicle control may comprise limited functionality. For example, the limited functionality may be that the adaptive cruise control system does not reduce the speed of the vehicle in response to detecting another vehicle. In another example, the overall speed of the vehicle 100 may be reduced, for example, where a failure is identified in the primary sensor device 1500A and the fallback sensor device 1500B is not responding. In yet another example, the fallback path planning processing unit 290 may display a visual or acoustic warning requesting the driver take over manual operation of the vehicle 100, and ceasing reliance on the automotive safety system 200.

In some embodiments, the fallback planning processing unit 290 may also or alternatively determine alternate navigation. In some embodiments, the alternate navigation may comprise directions or instructions presented to the driver directing the driver to a service station nearby, exiting a freeway or expressway system, stopping the vehicle 100, or otherwise instructing the driver to operate the vehicle 100 in a safe manner in view of the identified failure. In another embodiment, the alternate navigation may be implemented by the vehicle without driver input, for example, the vehicle 100 may reduce speed until stopped or may contact a nearby service center to notify the center about the identified failure. While specific example alternate navigation is provided herein, these are not intended to be limiting and other possibilities are possible within the scope of this disclosure.

In some embodiments, the automotive safety system 200 may also comprise a plurality of additional sensor devices 1500C. The additional sensor devices 1500C may be, for example, supportive sensors that may assist with the operation of the vehicle 100, but are unable to be primary sensor device. Additional sensor device 1500C may be, for example, map data stored in a database indicative of terrain and structure locations as well as road maps (e.g., data used for GPS navigation systems). Other additional sensor device 1500 may include global navigation satellite systems (GNSS), inertial measurement units, etc. Such data may be transmitted to a localization unit 240, which may be configured to translate the data into local formats for use in the vehicle 100. This data may be used by the sensor fusion processing unit 270 to stitch together data representative of the environment surrounding the vehicle 100.

FIG. 2B schematically illustrates another example automotive safety system 200 comprising a sensor device 1500 and an integrated circuit 1600 (labeled in FIG. 2B as, for example, IC). The automotive safety system 200 may also comprise a communication link 210 between sensor device 1500 and integrated circuit 1600 to facilitate the transfer of data therebetween. For example, the communication link 210 may facilitate transfer of data as described above in connection to FIG. 2A. Upon receipt of data from sensor device 1500, the integrated circuit 1600 performs signal processing and, in some embodiments, stores the processed data for later use. As described above in connection to FIG. 1, the integrated circuit 1600 may be part of, or may transmit the processed data to, one or more safety applications of an automotive vehicle 100. In some embodiments, the automotive safety system 200 may be camera based system-on-a-chip (SOC) that integrates the various components of the automotive safety system 200 onto a single chip.

As an illustrative embodiment, the sensor device 1500 is an image-based sensor device (e.g., a camera) comprising an optical assembly and image sensor. The optical assembly may be arranged with one or more lenses to collect light from the environment in front of the optical assembly, and transfers this light to the image sensor. The image sensor receives the light from the optical assembly, captures the light as an image frame 205 (illustrated as rectangles in FIG. 2), and produces image data representative of each image frame 205. In some embodiments, rectangles 205 may also be referred to as “sensor data frames” that are generated based on captured “sensor data,” for example when a non-image based sensor device is utilized. The sensor device 1500 may be configured to capture a plurality of image frames 205a to 205n (collectively hereinafter “205”) within a given time period based on a capture frame rate. In some embodiments, the image frames may be sequential frames of a video stream that is indicative of a scene captured by the sensor device. The capture frame rate may be based on design specifications of the sensor device 1500 or the components thereof. For example, the sensor device 1500 may be capable of operating at 30 frames per second (fps), 60 fps, 90 fps, etc.

The sensor device 1500 may be configured to transmit the image frames, as image data, to an integrated circuit for image processing. As described throughout the present application, the image data may be used in connection to ADASs and surround view systems.

While the description herein is directed to an image-based automotive safety system, the present disclosure is not so limited. As described above, the use of non-image-based sensor devices is envisioned within the scope of the present disclosure, for example, acoustic-based sensor devices, pressure-based sensor devices, inertial-based sensor device, etc. For example, in an acoustic-based system, the sensor devices may capture a plurality of acoustic frames (e.g., a chirp or other sound) and generate a data frame that is sent to the integrated circuit. Other sensor devices may generate non-image based data frames in a similar manner Accordingly, similar processes and functions that are described in reference to an image-based automotive safety system may be equally applicable to non-image-based automotive safety systems.

In some embodiments, the integrated circuit 1600 is configured to sequentially receive the plurality of image frames 205 from the sensor device 1500 via communication link 210 (e.g., a wired or wireless connection). The integrated circuit 1600 is configured to execute processing techniques (e.g., as described in connection to FIG. 16) on the data of each image frame 205 for use in, for example, safety applications. The integrated circuit 1600 may output the processed image data at a processing frame rate. The processing frame rate may be indicative of the number of frames that the integrated circuit 1600 is capable of processing within a given time period. In some embodiments, the processing frame rate may be the same as the operating frame rate of the sensor device 1500. However, in other embodiments, the processing frame rate may be different. For example, the integrated circuit 1600 may operate at a faster frame rate than the sensor device 1500. The operating frame rate of the automotive safety system 200 may be based on a combination of the capture frame rate of the sensor device 1500 and the processing frame rate of the integrated circuit 1600 (e.g., 30 fps, 60 fps, 90 fps, etc.).

As described in connection to FIGS. 1 and 2, for safety applications, sensor devices 1500 may be used as an input sensor configured to capture image data for use by an ADAS or surrounding view systems. Accordingly, the various components of the automotive safety system 200 need to fulfill the functional safety requirements of ISO 26262. A failure to correctly capture image data, provide the image data to the integrated circuit, and/or correctly process the image data may result in a violation of the safety goals corresponding to a given ASIL. For example, a failure of the automotive safety system to provide a continuously updated image (e.g., a frozen image video stream) during a forward or rear view operation may lead to failure of the ADAS to provide adequate warnings of the presence of an object. The failure of the ADAS may be identified as a failure as described above in connection to FIG. 2A. Accordingly, there is a need for a systematic methodology to ensure that the safety goals are not violated due to failures or faults in the input sensor device, the communication link, and/or the image processing performed by the integrated circuit 1600.

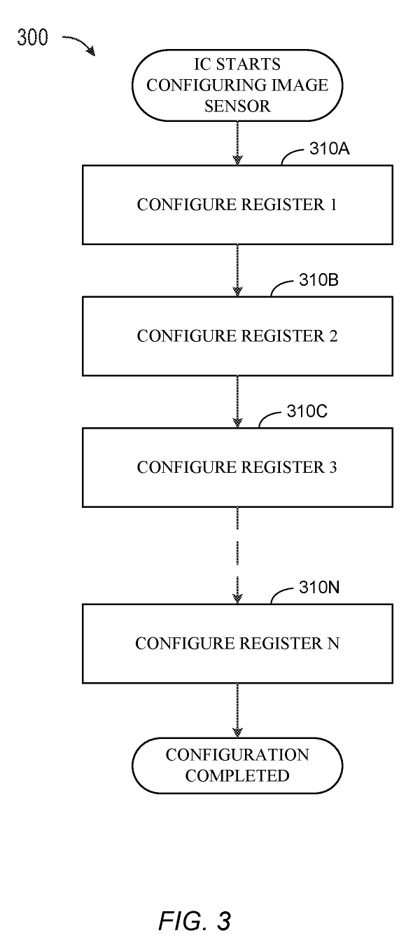

FIG. 3 illustrates a flowchart depicting an example process 300 of configuring the components of an ADAS to identify a failure of those components. The flowchart 300 may be implemented in an automotive safety system, for example, automotive safety system 200 as described herein. Although the process in FIG. 3 is illustrated in a particular order, in certain embodiments the blocks herein may be performed in a different order, or omitted, and additional blocks can be added. The process 300 may be implemented in any automotive safety system 200 as described herein to configure the automotive safety system 200.

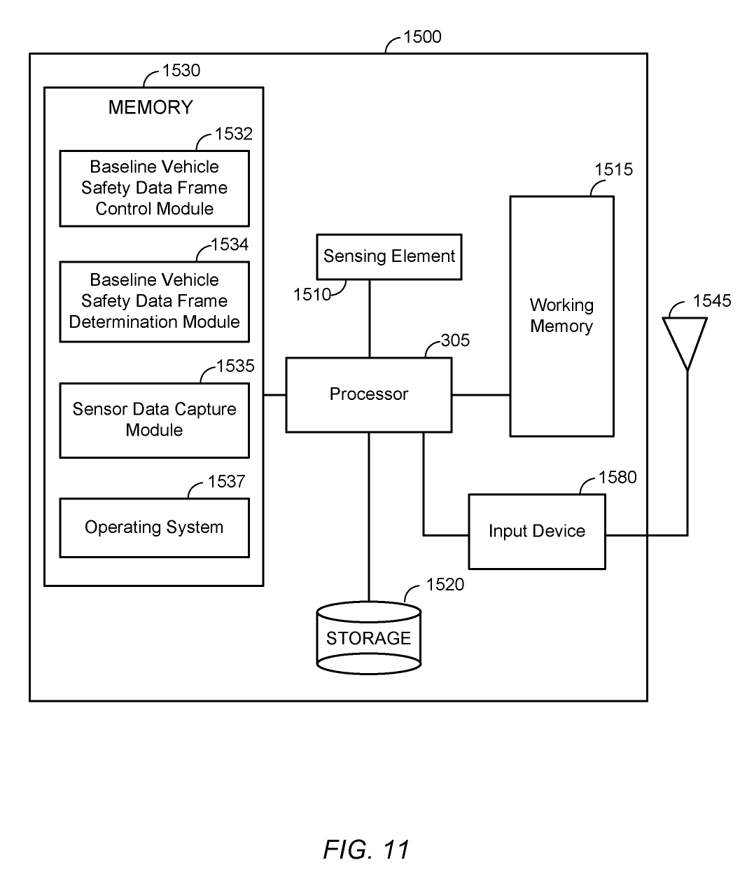

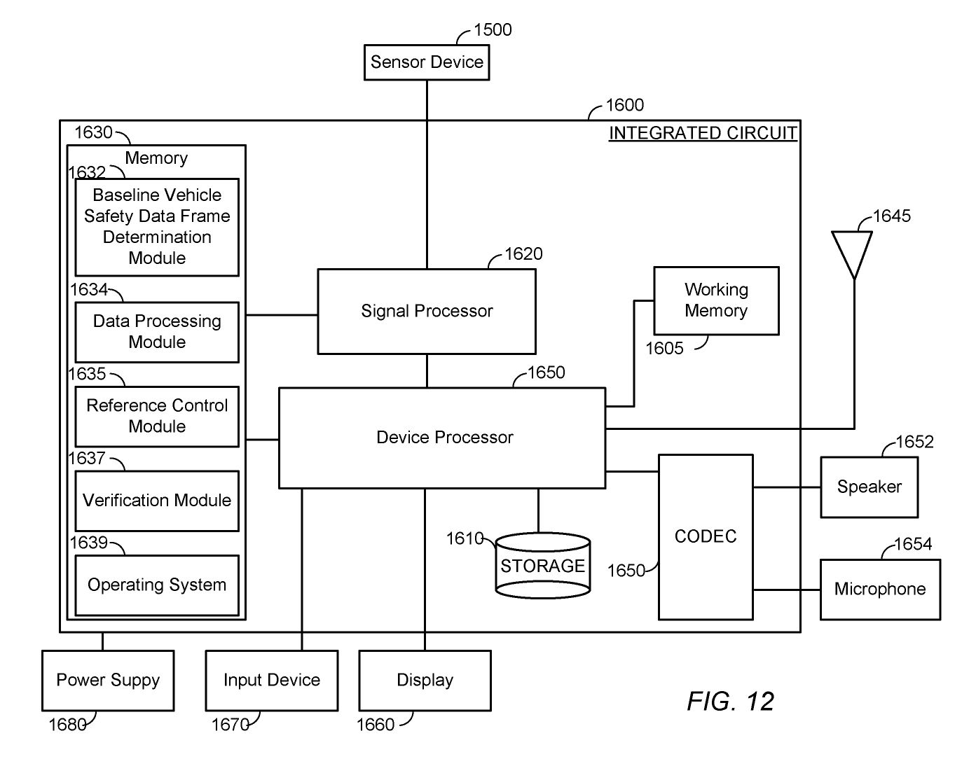

At the start of process 300, the automotive safety system is programed by the user with the configuration data including identified of the capabilities of the components. The configuration data will be described in more detail below in connection to FIGS. 11-12D. At block 310A, a first register is configured with the configuration data. For example, the first register may be one of the sensor devices of the automotive safety system. To configure the entire automotive safety system, the configuration data is sent to each register (e.g., register 2-N) in blocks 310B-310N. For example, the integrated circuit transmits the configuration data to each sensor device individually. Accordingly, the integrated circuit may be able to transmit configuration data to the sensor device to program and configure these components to identify failures therein.

Current implementations of the automotive safety applications lack an ability to ensure safe operation within the requirements of ISO 26262 during operation of the systems in the field and in real-time. Some implementations may be capable of self-testing the integrated circuit, but are currently unable to concurrently test the sensor device and the integrated circuit while operating. However, these methods are merely capable of testing the processing, reading, or writing of image data at the integrated circuit. The current implementation do not account for faults in the sensor device or communication link between the sensor device and integrated circuit, because the testing is based on data read from the memory of the integrated circuit and processed by the integrated circuit. Accordingly, current implementations may be unable to detect permanent or transient faults in the memory of the integrated circuit due to the absence of parity or error-correction code in memories of the automotive safety system. Therefore, there is an absence of periodic hardware self-test methodologies to perform concurrent self-test of the logic devices and memories of the sensor devices and subsystems.

Embodiments of the present application are directed to methods and systems for ensuring integrity of automotive safety system (e.g., automotive safety system 200). Embodiments disclosed herein are also directed to ensuring the integrity of automotive safety systems used for automotive safety applications. Accordingly, various embodiments are directed to a systematic methodology of testing the components of automotive safety systems (e.g., sensor device 1500 and integrated circuit 1600). Embodiments disclosed herein may also test the integrity of the communication link between the components of the sensor device.

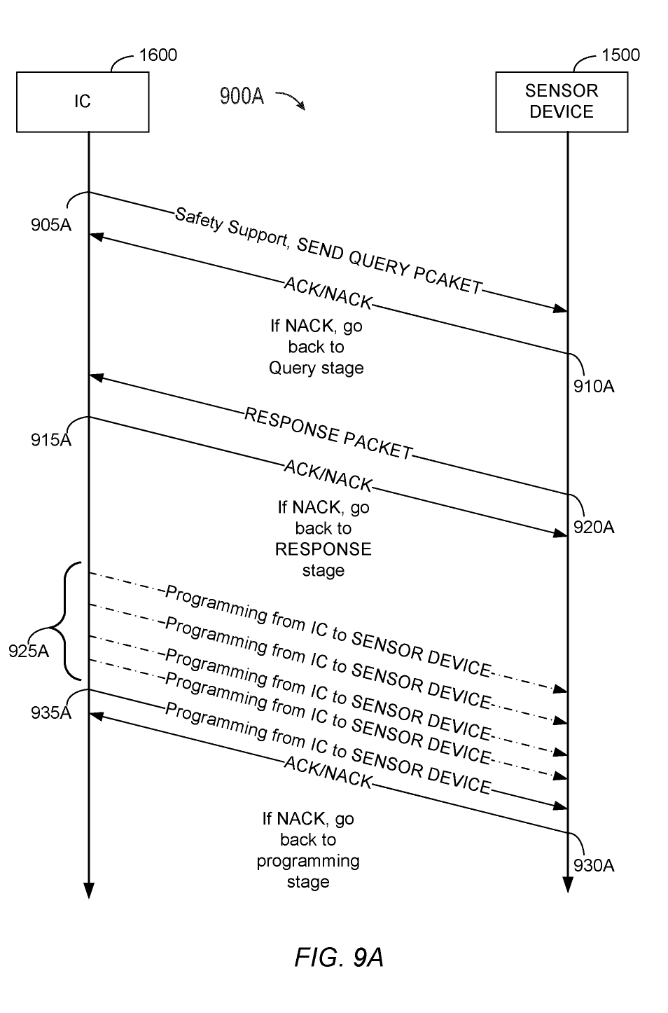

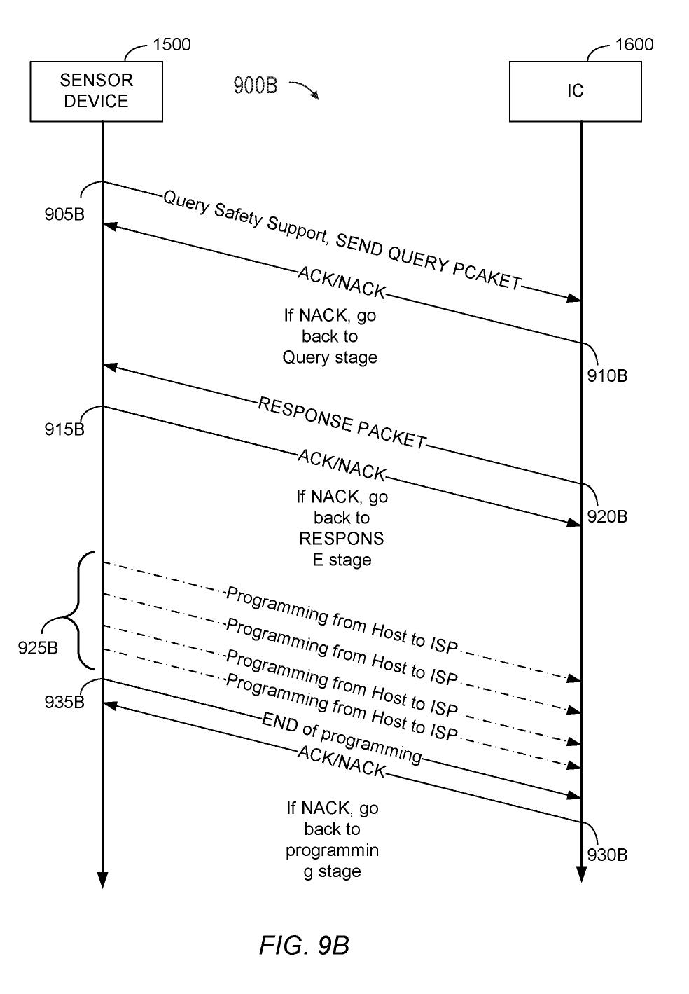

Embodiments disclosed herein may also support a message-based protocol between the integrated circuit and one or more sensor devices associated with a vehicle (e.g., vehicle 100 of FIG. 1). The message-based protocol (e.g., FIGS. 9A and 9B) may facilitate the exchange of messages between the integrated circuit and one or more sensor devices to program the one or more sensor device and/or integrated circuit such that the integrity of the automotive safety system may be tested as described above. In some embodiments, the message based protocol may comprise sending sensor capability safety support messages (e.g., FIG. 9A) between the integrated circuit and one or more sensors to determine sensor capabilities of the one or more sensor devices. The sensor capability safety support messages may be transmitted by the integrated circuit or from the one or more sensors. Embodiments herein may also receive identification data corresponding to the one or more sensor device, for example, in response to the sensor capability safety support messages. The identification data may comprise data responsive to the sensor capability safety support messages. As used herein the sensor capability safety support message may refer to a capability safety support message requesting identification data from the one or more sensor device (e.g., FIG. 9A). A sensor capability safety support message may also be referred to as an integrated circuit capability safety support message that, for example, is requesting identification data from the integrated circuit (e.g., FIG. 9B). The sensor and/or integrated circuit capability safety support message may be referred to generally as a capability safety support message.

Embodiments herein may be performed concurrently and in real-time while automotive safety systems are in operation in the field, thereby facilitating concurrent self-test of the input sensor devices and integrated circuit to ensure compliance with ISO 26262 throughout the systems' operation and lifecycle. For example, various embodiments of this application are directed to ensuring safe operation and/or safe operational degradation of hardware and software components of an ADAS throughout operation in the field and its lifecycle, in compliance with ISO 26262. Various embodiments of the systems and methods herein transmit one or more test frames to the sensor device based on the FTTI associated with the ASIL of the safety application. Image data representative of a test frame may be transmitted to the integrated circuit and processed therein. The resulting processed data may be verified against a known or expected result to verify that the automotive safety system and its components are operating as deigned. In another embodiment, alone or in combination, the number of test frames may be adaptively auto-calibrated based on a selected FTTI.

The term “concurrent,” as used throughout this application, may refer to “at approximately the same time” or performed in “parallel.” For example, embodiments disclosed herein may be configured to self-test the input sensor at approximately the same time as testing the integrated circuit, or in parallel with operation of the automotive safety system for use in one or more safety applications. Furthermore, as used herein, the term “concurrent test,” “concurrent self-test,” or variations of the term may refer to tests configured to continuously and repetitively check for errors or malfunctions due to faults in the systems. A “concurrent test” may refer testing the systems described herein without entering a dedicated testing mode, such that the systems may continue to operate as designed without notice by the user.

The term “associated,” as used throughout this disclosure, may refer to “connected with something, element, component, etc.”; “to join or connect together”; or “to bring together or into relationship in any of various tangible or intangible ways.” For example, a sensor device and integrated circuit may be associated with a vehicle because they are physically connected to the vehicle (e.g., a tangible relationship between the sensor device, integrated circuit and the vehicle). In another example, sensor capabilities stored in a memory may be associate with a given sensor device because the sensor capabilities provide identification of operating parameters and capabilities of that sensor device (e.g., an intangible relationship between the data representing the capabilities and the sensor device).

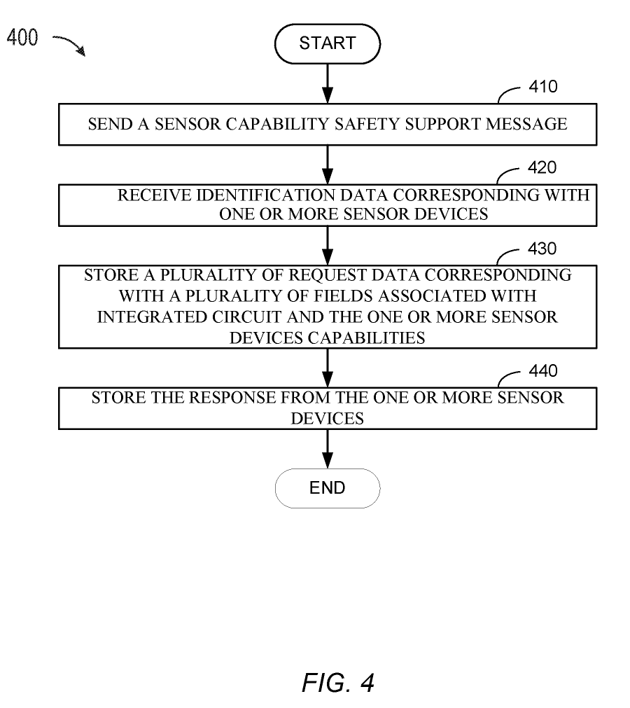

FIG. 4 illustrates a flowchart depicting another example process 400 of configuring the automotive safety system 200, in accordance with an exemplary implementation. As described in connection to FIG. 2B, the automotive safety system 200 comprises a sensor device 1500 and integrated circuit 1600, each including various hardware and software components for testing the automotive safety system 200 (e.g., described below in connection to FIGS. 14 and 15). The automotive safety system 200 may support a message-based protocol, as described herein, between the integrated circuit 1600 and one or more sensor devices 1500 associated with the vehicle. Although the process in FIG. 4 is illustrated in a particular order, in certain embodiments the blocks herein may be performed in a different order, or omitted, and additional blocks can be added. The process of the illustrated embodiment may be implemented in any automotive safety system 200 of FIGS. 2A and 2B.

At block 410, a sensor capability safety support message is transmitted as part of the message-based protocol. In some embodiments, the sensor capability safety support message may be a query message as described below in connection to FIGS. 9A and 9B. In some embodiments, the sensor capability safety support message may comprise a plurality of data corresponding with a plurality of fields supported by the message-based protocol. The plurality of fields may comprise, for example, a query ID field, a test frame type query field, a frame rate query field, and a calibration type query field. In some embodiments, the sensor capability safety support message may be transmitted by the integrated circuit to the one or more sensor devices (e.g., as a integrated circuit capability safety support message). In another embodiment, the sensor capability safety support message is transmitted from the one or more sensor devices to the integrated circuit.

At block 420, identification data corresponding with one or more sensor devices is received. In some embodiments, the identification data may be included in a response message as described below in connection to FIGS. 9A and 9B. In some embodiments, the identification data may comprise a plurality of data corresponding with a plurality of fields supported by the message-based protocol. The plurality of data may be responsive to the plurality of data of the sensor capability safety support message. The plurality of fields may comprise, for example, test frame type field, a frame rate field, and a calibration type field. In some embodiments, the identification data may be transmitted by the one or more sensor devices to the integrated circuit, in response to receiving sensor capability safety support message at the one or more sensors. In another embodiment, the sensor capability safety support message is transmitted from the integrated circuit to the one or more sensor devices, in response to receiving sensor capability safety support message at the integrated circuit.

At block 430, a plurality of request data corresponding with the plurality of fields associated with the integrated circuit and the one or more sensor device capabilities are stored. For example, the automotive safety system may comprise a memory (e.g., FIGS. 14 and 16) configured to store messages and data therein. In some embodiments, the integrated circuit and/or sensor circuit may comprise a memory configured to store the sensor capability safety support message and the data comprised therein.

At block 440, the response including identification data is stored. For example, the identification data may be stored in a memory of the automotive safety system. In an embodiment, the sensor circuit and/or the integrated circuit may be configured to store the identification data.

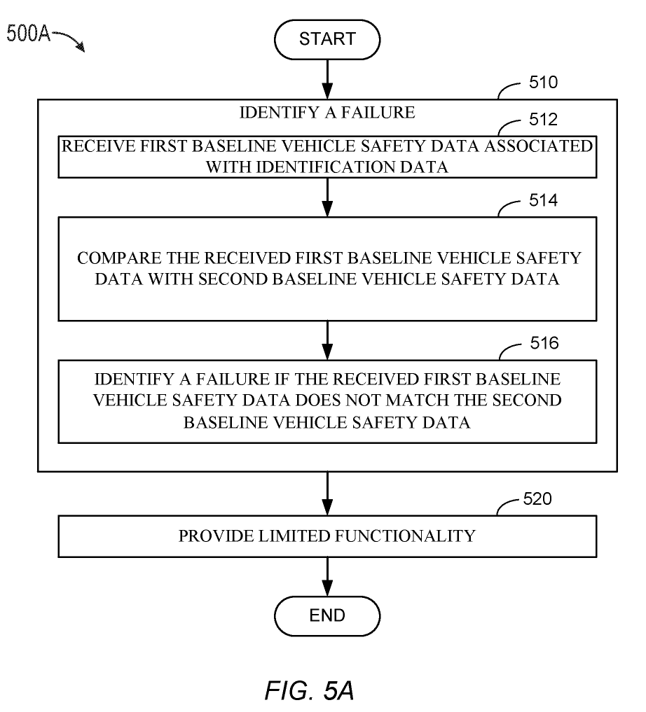

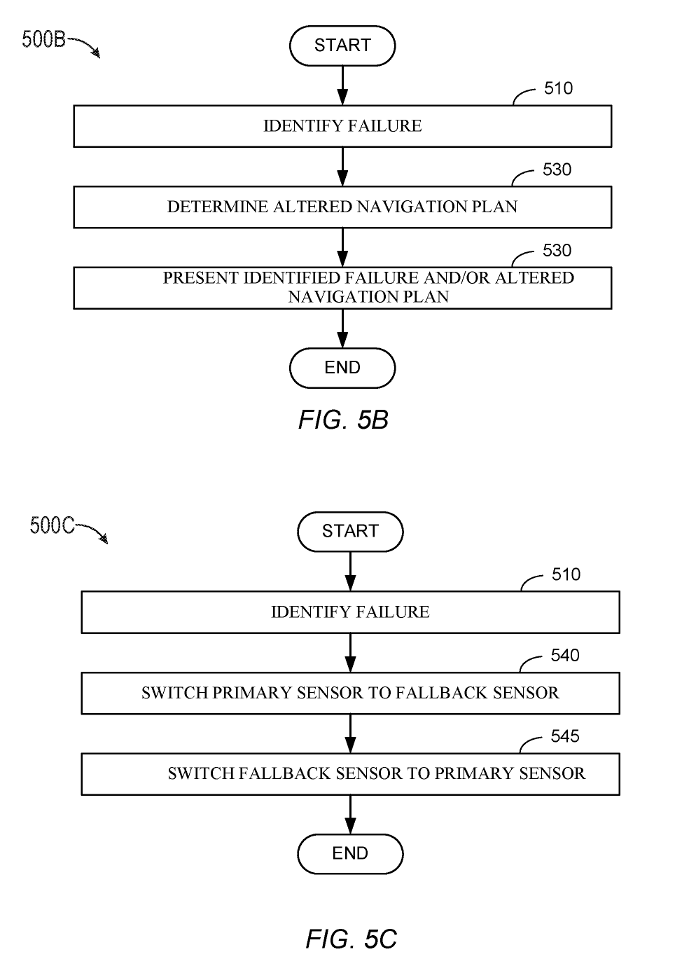

FIGS. 5A-5C illustrate flowcharts depicting example processes of operating the automotive safety system 200. For example, a failure of one or more sensors is identified. In response to the identified failure, the automotive system 200 may determine an operating flow path, for example, as described above in connection to FIG. 2A. Although the processes in FIGS. 5A-5C are illustrated in a particular order, in certain embodiments the blocks herein may be performed in a different order, or omitted, and additional blocks can be added. The processes of the illustrated embodiments may be implemented in any automotive safety system 200 of FIGS. 2A and 2B.

For example, FIG. 5A illustrates a flowchart depicting process 500 for providing limited functionality of a vehicle 100. The vehicle 100 may comprise a plurality of automotive safety systems 200 (e.g., FIG. 1); each including various hardware and software components for testing the automotive safety system 200 (e.g., described below in connection to FIGS. 14 and 15). The automotive safety system 200 may support a message-based protocol, as described herein.

At block 510, a failure of one or more sensor device is identified. As will be described in more detail below in connection to FIGS. 7-9B, the automotive safety system may be configured to test the integrity of the components therein. For example, at sub-block 512 the integrated circuit may be configured to receive a first baseline vehicle safety data from the given sensor device. The first baseline vehicle safety data may be derived from or associated with identification data corresponding to the given sensor device and based on the message-based protocol (e.g., FIG. 4). The first baseline vehicle safety data may be received during a first time segment. The first time segment may repeat periodically or asynchronously. The frequency and repetition may also be based on the identification data, as described below.

At sub-block 514, the received first baseline vehicle safety data is compared with a second baseline vehicle safety data. In some embodiments, the second baseline vehicle safety data is stored in a memory of the given sensor device. In some embodiments, the second baseline vehicle safety data may also be derived from the identification data corresponding to the given sensor device.

At sub-block 516, a failure is identified if the received first baseline vehicle safety data does not match the second baseline vehicle safety data. For example, the first baseline vehicle safety data may be an image test frame (e.g., as will be described in more detail below in connection to FIGS. 11-12B) transmitted from the given sensor device. The sensor device may derive the image test frame based on data included in the identification data. The integrated circuit may store a second baseline vehicle safety data as a known image test frame, which is similarly derived from or associated with the identification data. Upon receiving the image test frame from the given sensor device, the integrated circuit detects a failure if the image test frame and known test frame do not match. In another embodiment, where the sensor device is a LIDAR sensor, the first and second baseline vehicle safety data may be based on LIDAR test frames, such as known light detection by a light detector at the sensor device. In another embodiment, where the sensor device is a RADAR sensor, the first and second baseline vehicle safety data may be a known chirp having different frequencies and/or amplitudes of known magnitudes.

Referring to FIG. 5A, if a failure is identified at block 510, a limited functionality is provided at block 520 for operating the vehicle. For example, the automotive safety system may modify operation, e.g., reducing speed of the vehicle, initiating a control maneuver, etc., when the fallback sensor device is also not responding. In some embodiments, a warning may be presented to the driver requesting driver input for operating of the vehicle opposed to control via the automotive safety system.

Referring to FIG. 5B, if a failure is identified at block 510, at block 530 an altered navigation plan is determined. For example, as described above in connection to FIG. 2A, the automotive safety system may determine alternate navigation that may include modifying a current route of the vehicle. At block 535, the identified failure or the altered navigation plan is presented to the use. For example, the vehicle 100 may comprise a display (e.g., FIG. 12) for displaying the navigation plan to the driver (e.g., as a navigation guidance system). The automotive safety system may alter the navigation plan as shown on the display to direct the driver according to the altered plan. In another embodiment, an acoustic description of the navigation plan or identified failure may be played over speakers in the vehicle 100. In some embodiments, the automotive safety system may be configured to stop the vehicle if the vehicle is not operated according to the altered navigation plan.

Referring to FIG. 5C, if a failure is identified at block 510, the designation of the sensor device may be switched at block 540 from primary to fallback sensor device. At block 545, the designation of another sensor device may be switched from fallback to primary sensor device. For example, as described in connection to FIG. 2A, the designation of the sensor device associated with the identified failure may be switched to ensure normal operation through the primary path planning processing unit 280.

While each process 500A-500C is described herein individually, this is not intended to be limiting. For example, each process 500A-500C is not mutually exclusive, and may be partially or fully implemented in combination with one or more of the other processes 500A-500C.

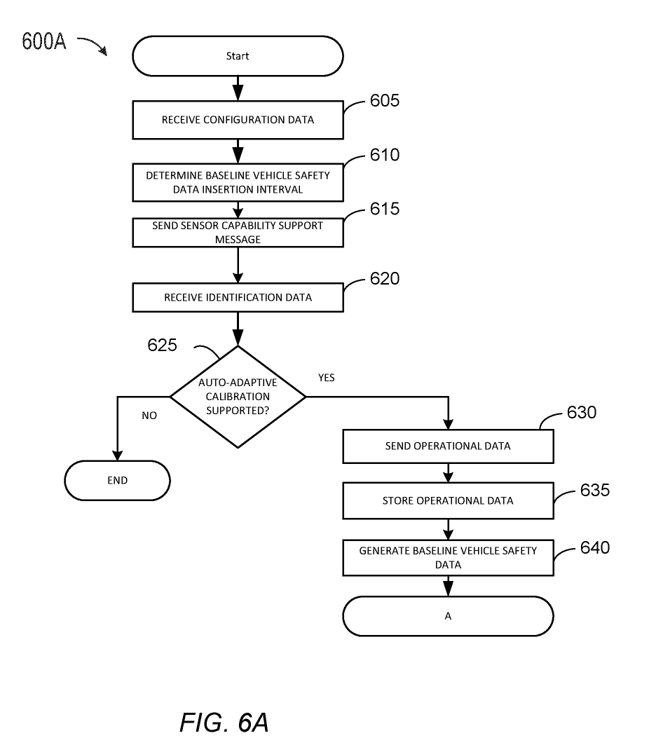

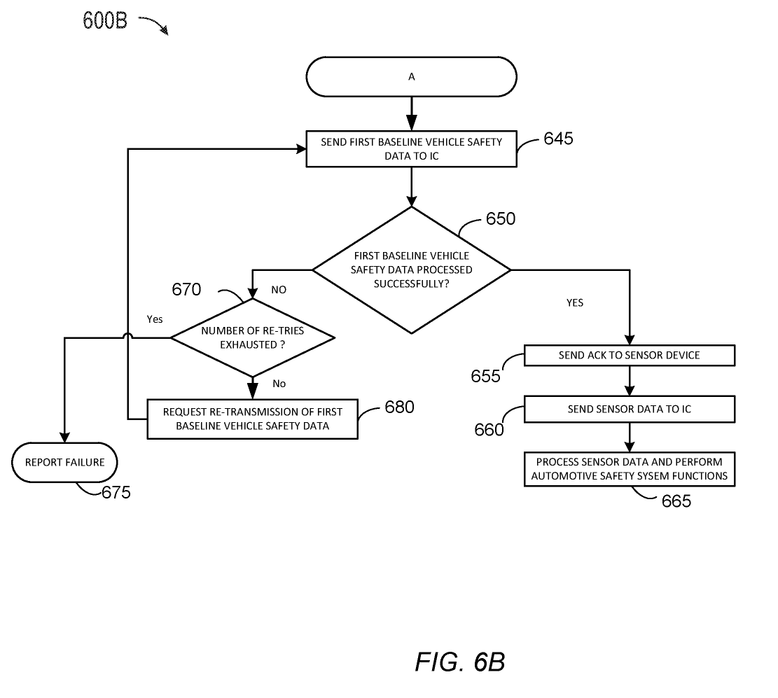

FIGS. 6A and 6B illustrates a flowchart depicting a method for implementing an automotive safety system, in accordance with an exemplary implementation. As described in connection to FIG. 2B, the automotive safety system 200 comprises an sensor device 1500 and integrated circuit 1600, each including various hardware and software components for testing the automotive safety system 200, for example, as described in connection to FIGS. 2A-5C. Although the process in FIGS. 6A and 6B is illustrated in a particular order, in certain embodiments the blocks herein may be performed in a different order, or omitted, and additional blocks can be added. The process of the illustrated embodiment may be implemented in any automotive safety system 200 in order to test the automotive safety system 200.

Turning to FIG. 6A an example process 600A for configuring the automotive safety system and components therein is illustrated.

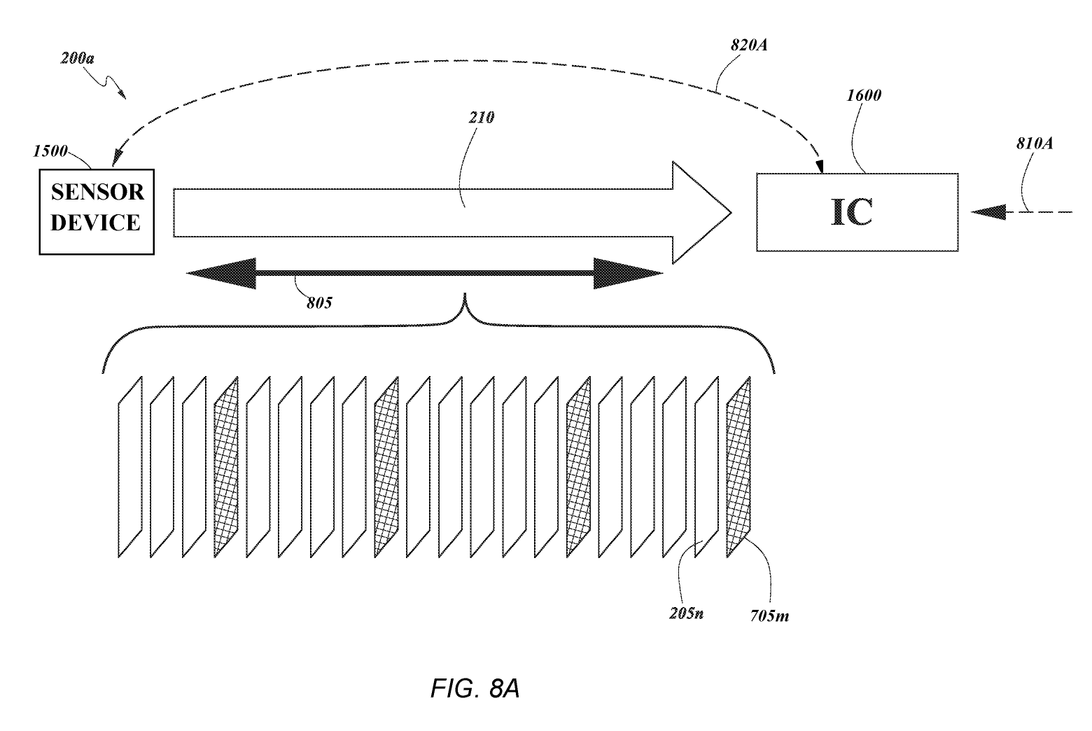

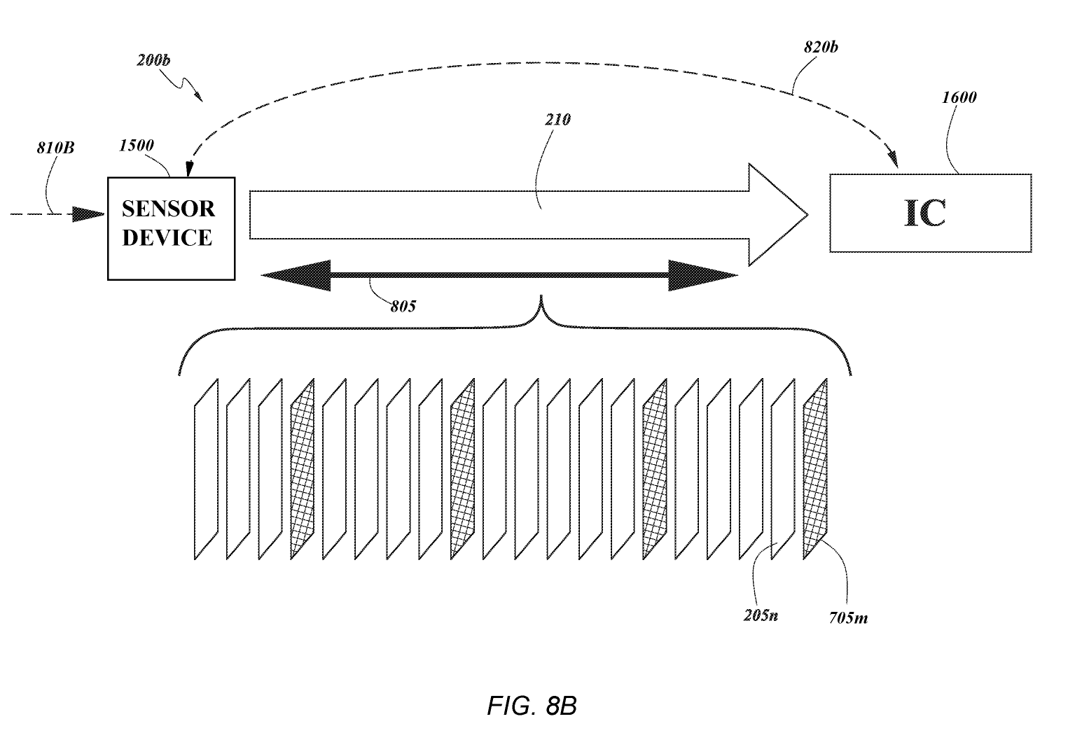

At block 605 configuration data is received. Configuration data may include frame rate and an FTTI of an ADAS. In some embodiments, the configuration data is supplied by a user (e.g., a driver, OEM manufacturer, etc.). For example, a user may program the integrated circuit with the configuration data, as described below in connection to FIG. 8A. In another embodiment, the user may program the sensor device, as described below in connection to FIG. 8B.

At block 610, a baseline vehicle safety data insertion interval is determined. In some embodiments, the baseline vehicle safety data insertion interval may be determined by the integrated circuit (e.g., FIG. 8A) or the sensor device (e.g., FIG. 8B).

In embodiments where the automotive safety system is used for safety applications, the baseline vehicle safety data insertion interval may be based on the configuration data of block 605. For example, the baseline vehicle safety data may be a number or insertion interval of baseline vehicle safety data may be determined based on the FTTI, as described below in connection to FIG. 7. As described above, the test frames are designed to test the various components of the automotive safety system to ensure that each component is operating as designed. For example, the test frames are designed to ensure that the sensor device, the integrated circuit, and the communication link therebetween is operating as expected. In some embodiments, the number of test frames is also based on the designed operating framerate of the integrated circuit. In some embodiments, the number of test frames may be determined by adaptively auto-calibrating the sensor device or the integrated circuit as described in connection to FIGS. 4A and 4B.

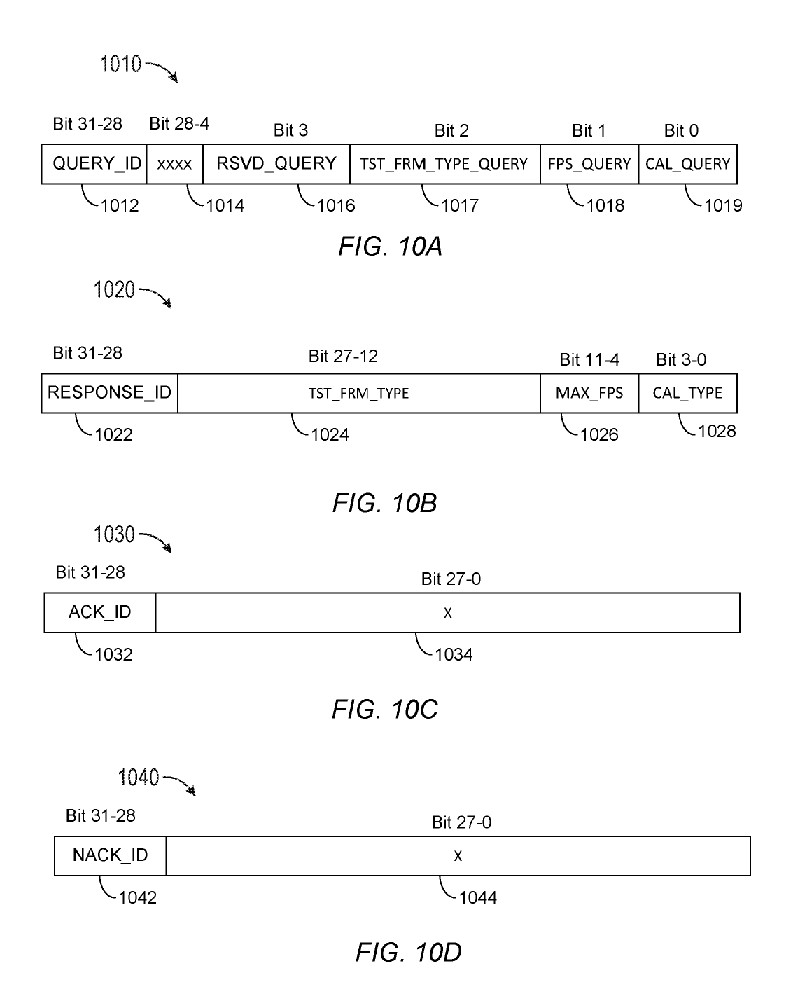

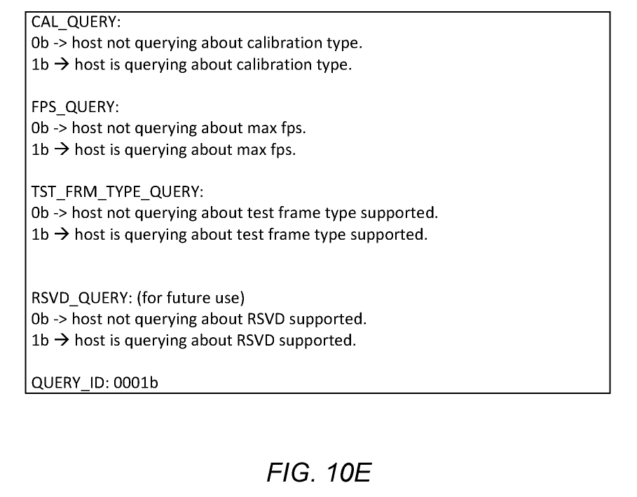

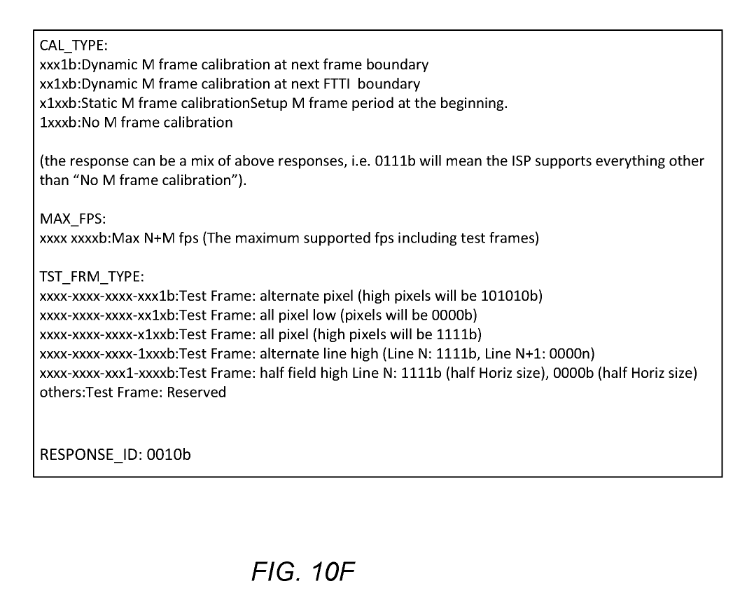

At block 615, a sensor capability support message is sent. As described herein, the sensor capability support message may be a query packet (as described below in connection to FIG. 10A). In some embodiments, the sensor capability support message comprises a plurality of data fields having data therein representative of requesting identification of capabilities of the automotive safety system. For example, the sensor capability support message may include data requesting an operating frame rate, a test frame type, or a calibration type. The sensor capability support message may be transmitted by the integrated circuit to one or more sensor devices (e.g., FIGS. 8A and 9A) or from the sensor device to the integrated circuit (e.g., FIGS. 8B and 9B).

At block 620, identification data is received. Identification data may be included in a response packet including data responsive to the inquires included in the sensor capability support message of block 615. For example, the identification data may include data identifying capabilities of the sensor device and/or integrated circuit. The identification data may be included in a plurality of fields, including for example a test frame type, operating frame rate, or calibration type. The identification data may be received by the integrated circuit from the one or more sensor devices (e.g., FIGS. 8A and 9A) or by the sensor device from the integrated circuit (e.g., FIGS. 8B and 9B).

At determination block 605, the process 600A determines whether auto-adaptive calibration is supported based, at least in part, on the information included in the identification data from block 620. For example, the identification data may include a calibration type field that includes data indicative of calibration capabilities, as described below in connection to FIGS. 9A and 9B. If auto-adaptive calibration is not supported, the process 600A ends. If auto-adaptive calibration is supported, the process 600A proceeds to block 630.

At block 630, operational data is sent. Operational data may include, for example, the configuration data of block 605 and baseline vehicle safety data insertion interval. The operational data may be transmitted by the integrated circuit to one or more sensor devices (e.g., FIGS. 8A and 9A) or from the sensor device to the integrated circuit (e.g., FIGS. 8B and 9B). In some embodiments, sending the operational data may comprise programming the one or more sensor devices by the integrated circuit or vice versa. Once the operational data is received, at block 636 the operational data is stored in, for example, a memory of the respective component (e.g., the sensor device or integrated circuit).

At block 640, baseline vehicle safety data is generated. The baseline vehicle safety data may be, for example, a test frame to be used to verify the integrity of the automotive safety system. As described above, the baseline vehicle safety data may be used to identify a failure (e.g., FIG. 6B). In some embodiments, the sensor device may generate a first baseline vehicle safety data based on the operational data stored therein. The integrated circuit may generate a second baseline vehicle safety data based on the operational data and store the second baseline vehicle safety data in a memory. The first and second baseline vehicle safety data may be stored for later use to identify failures

Turning to FIG. 6B, an example process 600B for verifying the integrity of the automotive safety system and components therein is illustrated.

At block 645, first baseline vehicle safety data is sent to the integrated circuit. The first baseline vehicle safety data may be transmitted by the sensor device over a communication link (as described below in connection to FIGS. 7-8B). For example, the first baseline vehicle safety data may be inserted between sequentially captured and transmitted data frames. In some embodiments, the first baseline vehicle safety data may be sent during a first time segment. In some embodiments, the first baseline vehicle safety data may be associated with identification data corresponding to a sensor device, for example, as described in FIG. 6A. For example, the first time segment may be based on the insertion interval determined in block 610 of FIG. 6A. In some embodiments, the first time segment may repeat periodically or asynchronously based on the insertion interval.

In some embodiments, the first baseline vehicle safety data may be a test frame inserted between sensor data frames. For example, an image-based sensor device may be configured to insert a test frame (e.g., first baseline vehicle safety data from block 640), between sequential image frames based on the insertion interval (e.g., from block 610). The test frames may be periodically or asynchronously inserted between image frames during operation of the automotive safety system. In some embodiments, where the sensor device is a RADAR system, the first baseline vehicle safety data may comprise a chirp frame. In other embodiments, where the sensor is a LIDAR system, the first baseline vehicle safety data may comprise a LIDAR test frame.

At determination block 650, the process 600B determines whether the first baseline vehicle safety data is processed successfully. For example, the automotive safety system may be configured to verify that it is operating correctly based on the processed first baseline vehicle safety data. For example, while the automotive safety system is operating, the processed first baseline vehicle safety data is compared to reference or known data, to ensure that the various components of the automotive safety system are communicating the first baseline vehicle safety data via a communication link correctly and processing the first baseline vehicle safety data correctly.

In some embodiments, the automotive safety system may be configured to verify that it is operating correctly based on second baseline vehicle safety data. For example, upon receiving the first baseline vehicle safety data at the integrated circuit, the integrated circuit may retrieve a second baseline vehicle safety data from a memory (e.g., block 640 of FIG. 6A). The second baseline vehicle safety data may comprise a known or expected data, such as a known test frame stored in a memory of the integrated circuit. Similar to the first baseline vehicle safety data, the second baseline vehicle safety data may be a test frame, chirp frame, LIDAR test frame, etc. The second baseline vehicle safety data is compared with each received first baseline vehicle safety data.

If the first baseline vehicle safety data does not match the second baseline vehicle safety data at block 650, then the process 600A proceeds to block 670 to identify whether a failure is present. At determination block 670, process 600B determines whether the number of re-tries for processing the first baseline vehicle safety data has been exhausted. The number of re-tries may be configured in the integrated circuit by a user (e.g., an OEM). The number of re-tries may be static or may be adjustable. In some embodiments, the number of re-tries may be a threshold value included in the configuration data (e.g., block 605). Exhaustion of the number of retries may be indicative of a failure in the automotive safety system, and the process 600B proceeds to end block 675 to report the failure (e.g., transmits the error to the primary or fallback perception units 250, 260 of FIG. 2A).

If the number of re-ties has not been exhausted, a request for re-transmission of the first baseline vehicle safety data is sent at block 680. For example, the integrated circuit may send a request for re-transmission of the first baseline vehicle safety data to the sensor device. In response to the request, block 645 may be repeated and the sensor device sends the first baseline vehicle safety data for re-processing at block 650.

If the first baseline vehicle safety data does match the second baseline vehicle safety data at block 650, then no failure is identified and the process 600B proceeds to block 655. At block 655, an acknowledgement message (ACK) is sent to the sensor device confirming the first baseline vehicle safety data has been processed successfully. Reception of the ACK message by the sensor device may be indicative that the automotive safety system is operating within designed parameters and functional safety requirements. Thus, the sensor device may proceed with sending sensor data (block 660) representative of the environment around the vehicle, which is processed by the integrated circuit to perform the functions of the automotive safety system (block 665), as described above.

In some embodiments, sensor data and first baseline vehicle safety data may be sequentially provided to the integrated circuit based on the order in which the sensor data was captured by the sensor device and the insertion interval determined, for example, in block 640. Sensor data in an image-based sensor device may be provided corresponding to each image frame, and first baseline vehicle safety data may correspond to each test frame. For example, as image frames are captured, the corresponding image data is transmitted to the integrated circuit. Similarly, as test frames are generated by the sensor device, the test frames are transmitted between transmissions of corresponding and sequential image frames. Upon receiving the image and test data, the integrated circuit processes the image data corresponding to each image frame and the test frame corresponding to each test frame, as described below in connection to FIGS. 7-8B.

FIG. 7 schematically illustrates an embodiment of an automotive safety system 200 configured to verify compliance with safety requirements. FIG. 7 depicts automotive safety system 200 comprising a sensor device 1500 and an integrated circuit 1600 in communication via communication link 210. The automotive safety system 200 of FIG. 7 is substantially similar to the automotive safety systems described in connection to FIGS. 2A and 2B. However, the sensor device 1500 is also configured to generate first baseline vehicle safety data corresponding to a plurality of first baseline vehicle safety data frames 705a through 705m (collectively hereinafter “705”). The first baseline vehicle safety data is transmitted to the integrated circuit 1600 and processed to verify that the automotive safety system 200 is operating correctly, as described above in connection to FIGS. 4-6B.

In an exemplary embodiment of an image-based sensor device, the first baseline vehicle safety data frames 705 may be test frames that are periodically inserted between image frames 205. The corresponding test and image data are sequentially transmitted to the integrated circuit 1600. The integrated circuit 1600 then processes the image and test data to generate processed image and test data while the automotive safety system 200 is operating in the field. For example, the processed image data may be used for imaging-based safety applications and the test data may be used to verify the automotive safety system 200 is operating correctly. Accordingly, a non-limiting advantage of embodiments described herein is that the automotive safety system 200 is capable of concurrently testing each component of the automotive safety system 200 while operating in the field. In some implementations, the automotive safety system 200 may be part of an ADAS. The testing may be carried out in image signal processing executed by the hardware components of the integrated circuit 1600 (e.g., signal processor 1620 of FIG. 12).

While the above example is described with reference to image-based sensor devices, it will be appreciated that non-image based sensor devices and image date may be used in a similar manner as described herein. For example, an acoustic data frame may be captured in place of an image frame and the first baseline vehicle safety data may be an acoustic test frame (e.g., a chirp as described above). The second baseline vehicle safety data may also be a known or expected chirp (e.g., known frequency and amplitude) for comparing with the first baseline vehicle safety data.

As described above in connection to FIGS. 2A and 2B, the sensor device 1500 may be configured to capture a plurality of sensor data, for example, image frames 205. The image frames 205 are transmitted via communication link 210 to the integrated circuit 1600. The image frames 205 may transmitted to the integrated circuit 210 sequentially as the image frames 205 are captured by the sensor device 1500. Upon receipt of each image frame 205, the integrated circuit 1600 executes image signal processing techniques to analyze the received images frames 205, as will be described below in connection to FIG. 7.

As described herein, first baseline vehicle safety data frames 705 are generated by the sensor device 1500, as described in more detail below and in connection to FIG. 11. For example, as illustrated in FIG. 7, a first baseline vehicle safety data frame 705a may be inserted between two sequential image frames 205, such that, the sensor device 1500 captures a first image frame 205c, a first baseline vehicle safety data frame 705a, and a second image frame 205d. In some embodiments, the first baseline vehicle safety data frames 705 may be data presented to the sensor device 1500 as described below in connection to FIGS. 10B and 11. For example, the first baseline vehicle safety data frame 705a may be generated, stored, and retrieved from a memory of the sensor device 1500 (e.g., storage 1520 of FIG. 11) The sensor device 1500 may transmit the first baseline vehicle safety data to the integrated circuit 1600 via communication link 210.

The first baseline vehicle safety data frames 705 may be a predetermined value based on a test frame type (e.g., as described in connection to FIG. 9B). The first baseline vehicle safety data frame 705 may be designed to ensure that all components of the automotive safety system are implemented in the test. In this example, the first baseline vehicle safety data frame 705 may be configured to confirm (1) that the sensor device 1500 is operating as designed, (2) the integrity of the communication channel between the sensor device 1500 and integrated circuit 1600, and (3) the integrity of the integrated circuit 1600 to produce an output that is representative of a given image frame. In some embodiments, each first baseline vehicle safety data frame 705 may comprise the same pattern. In other embodiments, alone or in combination, the first baseline vehicle safety data frames 705 may vary in pattern or design, or some may be varied while others are the same first baseline vehicle safety data frame. In some embodiments, the first baseline vehicle safety data frame 705 may be based on baseline vehicle safety data used to calibrate the automotive safety system 200 during testing and manufacturing or startup. The first baseline vehicle safety data frames 705 may be static and stored in a memory (e.g., a memory of the integrated circuit 1600 or the sensor device 1500); while in other embodiments the test frames may be dynamically changed.

The integrated circuit 1600 is configured to verify that the automotive safety system 200 is operating correctly based on the received first baseline vehicle safety data. For example, the integrated circuit 1600 executes processing on the first baseline vehicle safety data frame 705 to produce processed baseline vehicle safety data. The processed baseline vehicle safety data may be used in a comparison against an expected or known result (e.g., a second baseline vehicle safety data) that is indicative of the first baseline vehicle safety data frame 705 corresponding to the received first baseline vehicle safety data. In some implementations, the integrated circuit 1600 may be configured to retrieve reference data based on the first baseline vehicle safety data frame 705a. The reference or second baseline vehicle safety data may be representative of the expected result. The integrated circuit 1600 may be configured to retrieve the reference baseline vehicle safety data before receiving the first baseline vehicle safety data from the sensor device 1500, while the first baseline vehicle safety data is received, and/or after receiving the first baseline vehicle safety data, or any combination thereof. The integrated circuit 1600 may compare the processed first baseline vehicle safety data with the reference baseline vehicle safety data to verify that the sensor device 1500 and integrated circuit 1600 are communicating and processing the first baseline vehicle safety data frame 705 as designed.

In one embodiment, the verification that the automotive safety system 200 is operating correctly may be performed by computing a cyclic redundancy check (CRC) of the processed first baseline vehicle safety data and comparing this value to an expected CRC value (e.g., based on the reference baseline vehicle safety data). When the processed first baseline vehicle safety data CRC value is the same as the reference baseline vehicle safety data CRC value, the integrity of the automotive safety system 200 is verified. Otherwise, the integrated circuit 1600 may generate a signal indicative of the one or more faults or failures in the automotive safety system 200 (as described above in connection to FIGS. 2A and 2B). In another example, the expected reference baseline vehicle safety data may comprise data values representative of correct operation, which can be compared to the first baseline vehicle safety data comprising data values. While specific examples of comparing data corresponding to first baseline vehicle safety data frames are described herein, it is noted that other methods are possible for comparing data extracted from first baseline vehicle safety data frames, and that the embodiments disclosed herein should not be limited to the specific examples herein.

In various embodiments, the processed first baseline vehicle safety data (or CRC therefrom) must be an exact match to the reference baseline vehicle safety data (or CRC therefrom). Where an exact match occurs, the integrity of the automotive safety system 200 has been verified and the automotive safety system (may continue to operate undisturbed). In embodiments where the automotive safety system 200 is part of a safety application, the verification described herein may be indicative that the safety application and systems thereof are operating correctly. Otherwise, when a deviation is detected, the integrated circuit 1600 may generate a signal indicative of the one or more faults or failures in the automotive safety system 200 (as described above in connection to FIGS. 2A and 2B). In some embodiments, the automotive safety system 200 may execute a process to recover from the fault, by, for example, restarting the automotive safety system 200 or disregarding frames received from the automotive safety system 200. In another embodiment, the signal may be indicative of instructions to individually test the sensor device 1500 and/or integrated circuit 1600 to determine where a fault exists within the automotive safety system 200. In some embodiments, alone or in combination, the automotive safety system 200 may comprise sensors devices designated as primary sensor devices (see, e.g., primary sensor device 1500a of FIG. 2A) and fallback sensor devices (see, e.g., fallback sensor device 1500b of FIG. 2B). Here, the signal based on the identified failure may be indicative of switching the designation of the primary sensor device to a fallback sensor device and switching the designation of the fallback sensor device to a primary sensor device. Additionally or in a separate embodiment, as described above in connection to FIG. 2A, the signal may also be indicative of providing limited functionality of the vehicle 100 or presenting an altered navigation plan to a driver.

In various embodiments, the automotive safety system 200 may be configured to determine the number of first baseline vehicle safety data frames 705 or an insertion interval (e.g., FIG. 6A) to be provided to the sensor device 1500 based on a tolerance threshold time interval. The tolerance threshold time interval may be indicative of an amount of time, while the automotive safety system 200 is operating, that is free of a fault or failure in the operation of the automotive safety system 200 or components thereof. In some embodiments, the number of first baseline vehicle safety data frames 705 or insertion interval may also be based on the operating frame rate of the automotive safety system 200. In some implementations, the tolerance threshold time interval may be indicative of the number of first baseline vehicle safety data frames 705 to be evenly and periodically inserted between image frames 205 within one second of operating time of the automotive safety system 200. In another embodiment, the tolerance threshold time interval may be indicative of the insertion interval of the first baseline vehicle safety data frame 705, such that the first baseline vehicle safety data frame 705 is transmitted to the integrated circuit 1600 periodically or asynchronously.

Also as described above, to ensure integrity of systems used for safety applications, the systems need to satisfy the ISO 26262 requirements based, at least in part, on the ASIL associated with safety application. For example, in some embodiments the integrity of the automotive safety system 200 may be verified based on the FTTI, which may be one example of a tolerance threshold time interval. Thus, the automotive safety system 200 may be configured or programmed to test its component at least once every FTTI while the automotive safety system 200 is operating. Thus, the automotive safety system 200 may be programmed to insert a first baseline vehicle safety data frame 705 at least once every FTTI, and the integrated circuit 1600 may be programmed to verify the integrity of the automotive safety system 200 within at least one FTTI. Thus, identifying a failure may be based on an FTTI or tolerance threshold time interval, and designation of the sensor device (as described above); the providing limited functionality of the vehicle 100; or presenting an altered navigation plan to a driver may also be based therefrom. One non-limiting advantage of embodiments described herein is that the frequency of testing frames may be scaled according to the ASIL, for example, at the highest ASIL (e.g., ASIL D) test frames may be inserted more frequently than as required by a lower ASIL.

In some implementations, the automotive safety system 200 may be configured to determine the number of first baseline vehicle safety data frames 705 to be inserted between sequential sensor data frames and transmitted the integrated circuit 1600 based on the FTTI. In one embodiment, the number of first baseline vehicle safety data frames may be based on the FTTI and the operating frame rate of the automotive safety system 200. For example, the number of first baseline vehicle safety data frames 705 to be inserted within one second of operating time may be determined by taking the number of sensor data frames 205 (N) transmitted to the integrated circuit 1600 within one second (e.g., N=1/frame rate in fps) and multiplying by the FTTI (e.g., the time between each first baseline vehicle safety data frame 705). In one example, the operating frame rate is 60 fps and the FTTI is 300 milliseconds (e.g., corresponding to ASIL B applications), thus the number of first baseline vehicle safety data frames 705 (M) is 18 test frames. In some implementations, one test frame may be subtracted from this number to provide the integrated circuit 1600 extra time to process the test data within the selected FTTI. Therefore, the number of first baseline vehicle safety data frames (M) may be 17 for an FTTI of 300 ms and an operating frame rate of 60 fps. Accordingly, the number of first baseline vehicle safety data frames (M) may be described by:

M=floor(FTTI*N)−1 Eq. 1

where N is the number of sensor data frames 205 based on the operating frame rate.

In some embodiments where the automotive safety system 200 is used in an image-based safety application, the decisions and safety procedures of the safety application may be based on the results of the automotive safety system 200. For example, the automotive safety system 200 may process image frames 205 for use and analysis for making decisions in the safety application. In various embodiments, the decisions may be made based on the image data processed by the integrated circuit 1600. The decisions may be independent of the first baseline vehicle safety data 705, because this data may be used for testing the integrity and not indicative of a scene or condition surrounding, for example, the vehicle 100. Accordingly, in some embodiments, the safety applications may execute programming to make safety related determinations (e.g., identify an object in front of a vehicle for executing a collision warning, implementing adaptive cruise control, etc.) independent of the first baseline vehicle safety data. Thus, the operating frame rate of the automotive safety system 200 may be based on the number of image frames 205 (N) and the number of first baseline vehicle safety data frames 705 (M) processed within one second (e.g., the automotive safety system may operate at N+M fps). However, as described above, the integrated circuit 1600 may be configured to process more frames per second than the sensor device 1500 can capture. Accordingly, by inserting M first baseline vehicle safety data frames 705 within this difference in operating speeds, the operating frame rate may be minimally affected and the insertion of the test frames 705 would proceed unnoticed by the user of the automotive safety system 200.

Embodiments of the application herein may also be configured or programed to adaptively and automatically calibrate the first baseline vehicle safety data frames, the number of frame, and the insertion interval of frames to be provided to the automotive safety system 200. For example, FIGS. 8A and 8B schematically illustrate an example methodology for calibrating components of the automotive safety system of FIG. 2B. FIGS. 8A and 8B depict automotive safety system 200 configured to generate a plurality of first baseline vehicle safety data frames 705 with the sensor device 1500 and transmit first baseline vehicle safety data to the integrated circuit 1600, as described above in connection with FIG. 7. FIGS. 8A and 8B illustrate a two-way communication link 805 (wired or wireless) established between the sensor device 1500 and integrated circuit 1600. The two-way communication link 805 may be configured to support a message-based protocol between the sensor device 1500 and integrated circuit 1600 (e.g., as described in connection to FIGS. 4-6B and 9A-10D). In some embodiments, the two-way communication link 805 may be established over a wireless antenna, for example, communicator circuit 1545 and 1645 as described in connection to FIGS. 11 and 12, respectively. In some embodiments, the two-way communication link 805 may be established upon startup of the automotive safety system 200. In another embodiment, the two-way communication link 805 may be established when the sensor device 1500 and/or integrated circuit 1600 needs to communicate information or data to the other components. In some embodiments, the communication link 210 may be the two-way communication link 805. In another embodiment, the communication link 210 may be a separate or independent communication link configured for the transmission of data representative of the image and test frames.

FIG. 8A illustrates a method of adaptively calibrating the integrated circuit 1600. The configuration data (e.g., block 605 of FIG. 6A) may be programed at the integrated circuit 1600, which may communicate this data to the sensor device 1500 in a sensor capability support message (e.g., FIG. 10A), via two-way communication link 805. The configuration data may include a request for identification data from the sensor device 1500. The configuration data may also include operating parameters (e.g., operating frame rate of the automotive safety system and tolerance threshold time interval) that may be used to determine a first baseline vehicle safety data insertion interval. The sensor device 1500 may be configured to respond with a response message comprising identification data (e.g., FIG. 10B). The response message may comprise identification of the capabilities of the sensor device 1500, including calibration type support, first baseline vehicle safety data type supported, operating frame rate supported, etc.. For example, integrated circuit 1600 receives an input signal 810a (shown as a two-way arrow for illustrative purposes) from a source external to the automotive safety system 200. The input signal 810a may be indicative of the configuration data. The input signal 810a may be received by the integrated circuit 1600 as described below in connection to FIG. 12 and communicated to a processor) (e.g., device processor 1625 of FIG. 12).

In some embodiments, a user of the automotive safety system 200 (e.g., a driver, OEM manufacturer, etc.) may program the input signal in the integrated circuit 1600. In another embodiment, the user may operate a remote computer system to input the information to be included in the input signal, and this information is transmitted to the automotive safety system 200 as input signal 810a.

As described above, the input signal 810a may be indicative of the tolerance threshold time interval. In one embodiment, the input signal 810a comprises the tolerance threshold time interval. In another embodiment, the input signal 810a comprises information from which the tolerance threshold time interval may be derived (e.g., in the case of an FTTI, the ASIL or other information or instructions from which programing in the integrated circuit 1600 may be configured to derive or retrieve the FTTI). For example, the integrated circuit 1600 may include a memory configured to store a look-up table of ASILs and corresponding FTTI. The integrated circuit 1600 may receive the input signal 810a, including instructions, that when executed by one or more processors, causes the integrated circuit 1600 to retrieve the ASIL and associated FTTI from the memory. In another embodiment, the input instructions may include instructions to retrieve the tolerance threshold time interval from a database remote from the automotive safety system 200, e.g., by wireless communication with a remote storage.

The image subsystem 1600 may transmit a sensor capability support message via a signal 820a (shown as a two-way arrow for illustrative purposes) to the sensor device 1500 via the two-way communication link 805. In one embodiment, upon receiving the input signal 810a, the integrated circuit 1600 may execute instructions to establish the two-way communication link 805 to facilitate communication of the contents of the input signal 810a as the signal 820a. Establishing the two-way communication link 805 may include a “hand-shake” to establish parameters for communication between the integrated circuit 1600 and the sensor device 1500 (see, e.g., FIG. 9A). The integrated circuit 1600 and sensor device 1500 may be configured to exchange a series of messages to establish the communication link 805 before information and data may be exchanged between the two components. Once the communication link 805 is established, the integrated circuit 1600 may transmit the contents of the input signal 810a to the sensor device 1500. In one embodiment, the signal 820a may be similar to the input signal 810a. For example, the signal 820a may comprise the tolerance threshold time interval, FTTI, or the ASIL, from which the sensor device 1500 may derive or retrieve the tolerance threshold time interval therefrom (e.g., in a manner similar to that described above). In another embodiment, the integrated circuit 1600 may determine the number of first baseline vehicle safety data frames 705 or the insertion interval thereof and transmit this information as part of the signal 820a.

Upon receiving the signal 820a, the sensor device 1500 is configured (as described in connection to FIG. 11) to automatically calibrate itself for testing the automotive safety system 200 as described above in connection with FIG. 7. For example, once the sensor device 1500 receives the signal 820a, the sensor device 1500 (or a processor therein as described in connection to FIG. 11) may determine the number or insertion interval of the first baseline vehicle safety data frames based on the contents of the signal 820a. For example, the sensor device 1500 may determine the number of first baseline vehicle safety data frames based on the tolerance threshold time interval and/or the operating frame rate. The sensor device 1500 may proceed with inserting the first baseline vehicle safety data frames 705 between sequential sensor data frames 205. In some embodiments, the sensor device 1500 is configured transmit a response message including identification data in response to receiving the signal 820a. The integrated circuit 1600 may receive the response message transmit the configuration data to the sensor device 1500 based on the data included in the response message.

FIG. 8B illustrates another method of adaptively calibrating the automotive safety system. FIG. 8B is substantially similar to FIG. 8A; however, an input signal 810b is received at the sensor device 1500. The sensor device 1500 may communicate the contents of the input signal 810b with the integrated circuit 1600 (e.g., signal 820b) via two-way communication link 805.

The input signal 810b and signal 820b may be substantially similar to input signal 810a and signal 820b, respectively. Accordingly, input signal 810b may be received via an input from a user (OEM or similar) and indicative of the tolerance threshold time interval as described above. The input signal 810b may be communicated to a device processor of the sensor device 1500 (e.g., processor 1505 of FIG. 11). As illustrated in FIG. 8B, the sensor device 1500 may determine, derive, or retrieve the tolerance threshold time interval in a manner similar to that described above. The sensor device 1500 may be configured to establish two-way communication link 805 in a manner as described above, and, once established, the sensor device 1500 may transmit the signal 820b to the integrated circuit 1600 (see, e.g., FIG. 9B). The signal 820b may include a capability safety support message comprising data requesting an indication of the capabilities of the integrated circuit 1600.

Upon receiving the signal 820b, the integrated circuit 1600 may be configured to calibrate itself similar to the sensor device 1500 in FIG. 8A. Once the integrated circuit 1600 receives the signal 820b, it (or a processor therein as described in connection to FIG. 12) may transmit a response message (e.g., FIG. 10B) including identification data indicative of the capabilities of the integrated circuit based on the contents of the signal 820b. For example, the integrated circuit 1600 may determine the number or insertion interval of first baseline vehicle safety data frames 705 based on the tolerance threshold time interval therein (or derive therefrom) and/or the operating frame rate. By calibrating itself, the integrated circuit 1600 may be configured to identify data received from the sensor device 1500. For example, the integrated circuit 1600 may be able to distinguish image data from first baseline vehicle safety data so that the integrated circuit 1600 is able to process the data for the proper purpose (e.g., as image data or for verifying proper operation).

FIGS. 9A and 9B illustrates an example message flow of a message-based protocol in an automotive safety system. The message flow of FIGS. 9A and 9B may be implemented in the automotive safety system 200 of FIGS. 2A, 2B, and 7-8B. FIGS. 9A and 9B show example exchanges of various messages between an integrated circuit (e.g., integrated circuit 1600) and a sensor device (e.g., sensor device 1500). Each arrow represents a message transmitted from one component and received by another component of the automotive safety system. In some embodiments, the messages may comprise a data packet, and each data packet may comprise a plurality of fields supported by the message-based protocol. Each field may comprise data for facilitating the exchange the messages. The data packets and contents therein are described in more detail below in connection to FIGS. 10A-10D.

FIG. 9A illustrates an example message flow 900A between the integrated circuit 1600 and sensor device 1500. The message flow 900A may be configured to establish a two-way communication (e.g., two-way communication 805 of FIG. 8A) between the integrated circuit 1600 and sensor device 1500. The message flow 900A may be also be configured to adaptively configure the sensor device 1500 based on configuration data from the integrated circuit 1600.

In some embodiments, the integrated circuit 1500 may transmit a message 905A to the sensor device. The message 905A may be representative of a sensor capability safety support message. In some embodiments, the sensor capability safety support message may comprise a query packet that is transmitted to one or more sensor devices 1500. After sending the sensor capability safety support message, the integrated circuit 1600 waits for a response from the one or more sensors devices 1500.

In response to receiving message 905A, a sensor device 1500 may send a message 910a representative of an ACK message (see, e.g., FIG. 10C) or NACK message (see, e.g., FIG. 10D) to the integrated circuit 1600. If message 910A is a NACK message, the integrated circuit 1600 restarts the message flow and resends message 905A.

Following transmission of an ACK message, the sensor device 1500 sends a message 920A to the integrated circuit 1600. The message 920A may comprise a response packet (see, e.g., FIG. 10B). In some embodiments, the response packet comprises a plurality of fields comprising identification data indicative of the capabilities of the sensor device 1500. After sending the message 920A, the sensor device 1500 remains idle.

In response to message 920A, the integrated circuit 1600 sends a message 915A comprising an ACK message or a NACK message. The ACK message and NACK message of message 915A may be similar to the ACK and NACK messages, respectively, of message 910A. If a NACK message is included in message 915A, the sensor device 1500 resends the message 920A.

Following reception of an ACK message, the integrated circuit 1600 transmits a plurality of messages 925A representative of programing the sensor device 1500. In some embodiments, programing the sensor device 1500 may comprise transmitting the messages including operational data comprising frames per second, baseline vehicle safety data insertion interval, etc. (see, e.g., block 630 of FIG. 6A). In other embodiments, alone or in combination, programming the sensor device 1500 may be similar to that described above in connection to FIG. 8A.

Once programming is completed, the integrated circuit 1600 sends message 935A. Message 935A may be representative of a programming complete indication. In some embodiments, message 935A may be configured to inform the sensor device 1500 that not further data is to be received. Following completion, the integrated circuit 1600 may send message 930A, which may comprise an ACK message or a NACK message. The ACK message and NACK message of message 930A may be similar to the ACK and NACK messages, respectively, of message 910A. Inclusion of a NACK message in message 930A may be representative that the programming was incomplete or unsuccessful, and the integrated circuit 1600 may be configured to resend programming messages 925A. Reception of an ACK message in message 930A may be representative that programming is complete and successful, and the automotive safety system has been programmed to perform testing of the components as described herein.

FIG. 9B illustrates an example message flow 900B between the integrated circuit 1600 and sensor device 1500. The message flow 900B may be configured to establish a two-way communication (e.g., two-way communication 805 of FIG. 8B) between the integrated circuit 1600 and sensor device 1500. The message flow 900B may be also be configured to adaptively configure the integrated circuit 1600 based on configuration data from the sensor device 1500 (e.g., FIG. 8B).

In some embodiments, the sensor device 1500 may transmit a message 905B to the integrated circuit 1600. The message 905B may be representative of an integrated circuit capability safety support message, which may be similar to the sensor capability safety support message. In some embodiments, the integrated circuit capability safety support message may comprise a query packet that is transmitted to the integrated circuit 1600. After sending the integrated circuit capability safety support message, the sensor device 1500 waits for a response from the integrated circuit 1600.

In response to receiving message 905B, the integrated circuit 1600 may send a message 910a representative of an ACK message (see, e.g., FIG. 10C) or NACK message (see, e.g., FIG. 10D) to the sensor device 1500. If message 910B is a NACK message, the sensor device 1500 restarts the message flow and resends message 905B.

Following transmission of an ACK message, the integrated circuit 1600 sends a message 920B to the sensor device 1500. The message 920B may comprise a response packet (see, e.g., FIG. 10B). In some embodiments, the response packet comprises a plurality of fields comprising identification data indicative of the capabilities of the integrated circuit 1600. After sending the message 920B, the integrated circuit 1600 remains idle.

In response to message 920B, the sensor device 1500 sends a message 915B comprising an ACK message or a NACK message. The ACK message and NACK message of message 915B may be similar to the ACK and NACK messages, respectively, of message 910B. If a NACK message is included in message 915B, the se integrated circuit 1600 resends the message 920B.

Following reception of an ACK message, the sensor device 1500 transmits a plurality of messages 925B representative of programing the integrated circuit 1600. In some embodiments, programing the integrated circuit 1600 may comprise transmitting the messages including operational data comprising frames per second, baseline vehicle safety data insertion interval, etc. (see, e.g., block 630 of FIG. 6A). In other embodiments, alone or in combination, programming the integrated circuit 1600 may be similar to that described above in connection to FIG. 8B.

Once programming is completed, the sensor device 1500 sends message 935B. Message 935B may be representative of a programming complete indication. In some embodiments, message 935B may be configured to inform the integrated circuit 1600 that not further data is to be received. Following completion, the sensor device 1500 may send message 930B, which may comprise an ACK message or a NACK message. The ACK message and NACK message of message 930B may be similar to the ACK and NACK messages, respectively, of message 910B. Inclusion of a NACK message in message 930B may be representative that the programming was incomplete or unsuccessful, and the sensor device 1500 may be configured to resend programming messages 925B. Reception of an ACK message in message 930B may be representative that programming is complete and successful, and the automotive safety system has been programmed to perform testing of the components as described herein.

FIGS. 10A-10F illustrate examples of packet frame formats include in messages of the message-based protocol of FIGS. 9A and 9B. In some embodiments, each message may have a length comprising a plurality of bits. For example, in one embodiment, each message comprises a length of 32 bits. The frame format of each message may comprise a plurality of fields, each field associated with a subset of bits of the plurality of bits. The bits associated with each field may comprise data for carrying out the functions of each message, for example, as described above in connection to FIGS. 9A and 9B.

FIG. 10A is a block diagram illustrating an example query packet 1010, in accordance with an embodiment. As described above in FIGS. 9A and 9B, the query packet 1010 may be included in a sensor capability safety support message. The query packet 1010 may also be included in an integrated circuit capability safety support message. As illustrated, the query packet 1010 frame format may comprise an identification field (QUERY_ID) 1012, a payload field 1014, a reserved field (RSVD_QUERY) 1016, a test frame type query field (TST_FRM_TYPE_QUERY) 1017, a frame rate query field (FPS_QUERY) 1018, and a calibration type query field (CAL_QUERY) 1019. As used herein, “source component” may refer to either the integrated circuit 1600 (e.g., FIG. 9A) or the sensor device 1500 (e.g., FIG. 9B) and “target component” may refer to the sensor device 1500 (e.g., FIG. 9A) or integrated circuit 1600 (e.g., FIG. 9B).

In some embodiments, the identification field 1012 may comprise four bits at the beginning of the query packet 1010 and may indicate the packet type of the query packet. In some aspects, the identification field 1012 may include data indicating that the message comprises a query packet 1010. In one embodiment, a value of “0001b” in the identification field 1012 may indicate the message includes a query packet. However, other configurations are possible as desired for implementing the message-based protocol.

In some embodiments, the reserved field 1016 may comprise one bit following the payload field 1014 (which may comprise 24 bits). The reserved field 1016 may be a field reserved for future functionality and may indicate that the source component of the query packet is requesting information as to whether an additional functionality is supported or not. In some aspects, the reserved field 1016 may be implemented in accordance with the values listed in FIG. 10E. For example, a value of “0b” may indicate that the source component is not querying about support for additional functionality.

In some embodiments, the test frame type query field 1017 may comprise one bit following the reserved query field 1016. The test frame type query field 1017 may indicate that the source component is requesting about the type of baseline vehicle safety data frame (as described below in connection to FIG. 10B) the target component supports. In some aspects, the test frame type query field 1017 may be implemented in accordance with the values listed in FIG. 10E. For example, a value of “1b” may indicate that the source component is querying about the type of baseline vehicle safety data frame supported by the target component.

In some embodiments, the frame rate query field 1018 may comprise one bit following the test frame type query field 1017. The frame rate query field 1018 may indicate that the source component is requesting about the operating frame rate of the target component. In some embodiments, the request frame rate may be a maximum operating frame rate. In some aspects, the frame rate query field 1018 may be implemented in accordance with the values listed in FIG. 10E. For example, a value of “1b” may indicate that the source component is querying about what frame rate that the target component is capable of operating.

In some embodiments, the calibration type query field 1019 may comprise one bit following the frame rate query field 1018. The calibration type query field 1019 may indicate that the source component is requesting about the calibration type or format (as described below in connection to FIG. 10F) supported by the target component. In some aspects, the calibration type query field 1019 may be implemented in accordance with the values listed in FIG. 10E. For example, a value of “1b” may indicate that the source component is querying about the type of calibration supported by the target component.

FIG. 10B is a block diagram illustrating an example response packet 1020, in accordance with an embodiment. As described above in FIGS. 9A and 9B, the response packet 1020 may be included in a response message, and may comprise identification data indicative of the capabilities of the target component. As illustrated, the response packet 1020 frame format may comprise an identification field (RESPONSE_ID) 1022, a test frame type field (TST_FRM_TYPE) 1024, a frame rate field (MAX_FPS) 1026, and a calibration type field (CAL_TYPE) 1028. In some embodiments, the plurality of fields of the response packet 1020 may comprise identification data responsive to the requests indicated in the data included in the plurality of fields of the query packet 1010.

In some embodiments, the identification field 1022 may comprise four bits at the beginning of the response packet 1020 and may indicate the packet type of the response packet. In some aspects, the identification field 1022 may include data indicating that the message comprises a response packet 1020. In one embodiment, a value of “0010b” in the identification field 1022 may indicate the message includes a response packet. However, other configurations are possible as desired for implementing the message-based protocol.

In some embodiments, the test frame type field 1024 may comprise 16 bits following the identification field 1022. The test frame type field 1014 may indicate the type of baseline vehicle safety data frame supported by the target component. In some aspects, the test frame type field 1024 may be implemented in accordance with the values listed in FIG. 10F.

In one embodiment, a value of “xxxx-xxxx-xxxx-xxx1b” may indicate that the target component supports a baseline vehicle safety data frame comprising alternating values. For example, in an image-based automotive safety system, the baseline vehicle safety data frame may comprise image data indicative that a first pixel captured a high value and a neighboring pixel captured a low value (e.g., pixel values generated may be “101010b”). This pattern of high and low data is repeated for the entire sensing element of the sensor device.

In another embodiment, a value of “xxxx-xxxx-xxxx-xx1xb” may indicate that the target component supports a baseline vehicle safety data frame comprising all low values. For example, in an image-based automotive safety system, the baseline vehicle safety data frame may comprise image data indicative that all pixels captured a low value (e.g., pixel values generated may be “0000b”). In some embodiments, the low value may be a zero value, while in others the low value may be as low as possible in order to register some data at each pixel.

In another embodiment, a value of “xxxx-xxxx-xxxx-x1xxb” may indicate that the target component supports a baseline vehicle safety data frame comprising all high values. For example, in an image-based automotive safety system, the baseline vehicle safety data frame may comprise image data indicative that all pixels captured a high value (e.g., pixel values generated may be “1111b”). In some embodiments, the high value may be a value indicative of saturation of the sensor device, while in others the high value may just below saturation.

In another embodiment, a value of “xxxx-xxxx-xxxx-1xxxb” may indicate that the target component supports a baseline vehicle safety data frame comprising alternating lines of high and low values. For example, in an image-based automotive safety system, the baseline vehicle safety data frame may comprise image data indicative that of a first line of pixels captured high values (e.g., line N generates pixel values of “1111b”) and a second line of pixels captured low values (e.g., line N+1 generates pixel values of “0000b”).

In another embodiment, a value of “xxxx-xxxx-xxx1-xxxxb” may indicate that the target component supports a baseline vehicle safety data frame comprising a first line having half high values and half low values. For example, in an image-based automotive safety system, the baseline vehicle safety data frame may comprise image data indicative that of a first half of a line of pixels captured high values (e.g., line N generates pixel values of “1111b”) and a second half of the line of pixels captured low values (e.g., generates pixel values of “0000b”).

While specific examples of test frame types have been provided herein, it will be appreciated that other test frame types are possible. For example, additional values for the test frame type field 1024 (e.g., xxxx-xxxx-xx1x-xxxxb; xxxx-xxxx-x1xx-xxxxb, etc.) may be reserved for various other frame types as desired by the user of the automotive safety system. In some embodiments, the test frame type field 1024 may comprise a combination of two or more test frame types, for example, a value of “0000-0000-0001-1101b” may indicate that the target component supports each of the above described example baseline vehicle safety data frames except for the all low value frame type. Furthermore, in an acoustic-based automotive safety system the baseline vehicle safety data may be a chirp and the test frame type may be defined by modifying the frequency and/or amplitude of the chirp, based on the values of the test frame type field 1024.

In some embodiments, the frame rate field 1026 may comprise eight bits following the test frame type field 1024. The frame rate field 1026 may indicate that the operating frame rate of the target component. In some embodiments, the frame rate may be a maximum operating frame rate. In some aspects, the frame rate field 1026 may be implemented in accordance with the values listed in FIG. 10F. For example, the frame rate may be a value having a length “xxxx xxxx” indicative of a maximum frames per second that the target component supports. In some embodiments, as described above in connection to FIGS. 8A and 8B, the frame rate field 1026 may comprise data indicative of the total number of sensor data frames 205 and first baseline vehicle safety data frames 705 (e.g., N+M frames per second).

In some embodiments, the calibration type field 1028 may comprise 4 bits following the frame rate field 1026. The calibration type field 1028 may indicate the type of calibration supported by the target component. In some aspects, the calibration type field 1028 may be implemented in accordance with the values listed in FIG. 10F. For example, a value of “xxx1b) may indicate that the target component supports adaptive calibration (e.g., FIGS. 7-9B), where the target component can be updated with new configuration data (e.g., FIG. 6A) following each sensor data frame 205. In another example, a value of “xx1xb) may indicate that the target component supports adaptive calibration, where the target component can be updated with new configuration data (e.g., FIG. 6A) following after each threshold time interval (e.g., FTTI), as described above in connection to FIGS. 7-8B. In some embodiments, a value of “x1xxb” may indicate that the target component supports static calibration, where the baseline vehicle safety data frame 705 may be transmitted during startup of the automotive safety system. A value of “1xxxb” may indicate that the target component does not support calibration in accordance with embodiments herein.

While specific examples of calibration types have been provided herein, it will be appreciated that other calibration types are possible. Furthermore, in some embodiments, the calibration type field 1028 may comprise a combination of two or more test frame types, for example, a value of “0111b” may indicate that the target component supports each calibration type except for the no calibration type. Furthermore, in an acoustic-based automotive safety system the baseline vehicle safety data may be a chirp and the test frame type may be defined by modifying the frequency and/or amplitude of the chirp, based on the values of the test frame type field 1024.

FIGS. 10C and 10D are a block diagrams illustrating an example ACK packet 1030 and NACK packet 1040, in accordance with an embodiment. As described above in FIGS. 9A and 9B, the ACK and NACK packets 1030 and 1040 may be included in a messages following a message comprising a query packet, response packet, or ending the programming of the target component.

As illustrated in FIG. 10C, the ACK packet 1030 frame format may comprise an identification field (ACK_ID) 1032 and an empty field 1034. In some embodiments, the identification field 1032 may comprise four bits at the beginning of the ACK packet 1030 and may indicate the packet type is an ACK packet. In some aspects, the identification field 1032 may include data acknowledging successful receipt and processing of a previously transmitted message. In one embodiment, a value of “1111b” in the identification field 1032 may indicate the message includes an ACK packet.

As illustrated FIG. 10D, the NACK packet 1040 frame format may comprise an identification field (NACK_ID) 1042 and an empty field 1044. In some embodiments, the identification field 1042 may comprise four bits at the beginning of the NACK packet 1040 and may indicate the packet type is a NACK packet. In some aspects, the identification field 1042 may include data indicating unsuccessful receipt or unsuccessful processing of a previously transmitted message. In one embodiment, a value of “0000b” in the identification field 1032 may indicate the message includes a NACK packet.

While specific packets frame formats, values and field lengths have been described above, these are provided for illustrative purposes only. It will be appreciated that other configurations are possible for implementing message-based protocols in accordance with embodiments herein. For example, field lengths may be modified and varied as needed to fully request and indicate capabilities of the source and target components. Furthermore, values of the data contained in each field need not be the same as described herein, and may be defined as desired for different implementation of the embodiments herein.

FIG. 11 illustrates a high-level schematic block diagram of an embodiment of a sensor device 1500 according to embodiments herein. The sensor device 1500 may be part of the automotive safety system 200 of FIG. 7. The sensor device 1500 comprises a set of components, including sensing elements 1510. The sensor device 1500 may also include a processor 1505 operatively connected to the sensing elements 1510, working memory 1515, storage 1520, input device 1580, and a communicator circuit 1545. The processor 1505 is also operatively connected to a memory 1530. The memory 1530 stores several modules that store data values defining instructions to configure processor 1505 to perform functions of sensor device 1500, as will be described in more detail below.

Sensing elements 1510 may be components of a sensor device 1500 configured to receive an input and detect objects based on the received input. For example, in image-based automotive safety systems, the sensing elements 1510 may comprise an image sensor. Light enters a lens from the environment in front of the sensor device 1500 and is focused on the image sensor. In one aspect, the image sensor utilizes a charge coupled device. In another aspect, the image sensor utilizes either a CMOS or CCD sensor. The image sensor may be configured to capture a plurality of images of the environment based on the light received from the lens. Each image may be representative of an image frame (e.g., image frame 205) for use, for example, in safety applications. In some embodiments, the image frames may be the image frames 205 of FIG. 2B. The image sensor may include a plurality of pixels that receive the light from the lens and produce pixel values representative of the received image frame. The pixel values may be transmitted by the sensor device 1500 as image data.

The image sensor can have different processing functionalities in different implementations. In one embodiment, the image sensor may not process any data, and the processor may perform data processing. In another embodiment, the image sensor produces image data, which is communicated to the integrated circuit 1600 for processing.

While the foregoing and following description is made with reference to an image-based automotive safety system, such implementations are for illustrative purposes only. Other sensor elements may be comprised in sensor device 1500, for example, piezo element acoustic sensors, acoustic wave sensors, microphones, vibration sensors, pressure sensors, inertial sensors, accelerometers, actuators, etc.

In some embodiments, the processor 1505 may be configured to perform various processing operations on received image data. Processor 1505 may be a general purpose processing unit or a processor specially designed for safety applications. Examples of image processing operations include demosaicking, white balance, cross talk reduction, cropping, scaling (e.g., to a different resolution), image stitching, image format conversion, color interpolation, color processing, image filtering (e.g., spatial image filtering), lens artifact or defect correction, etc. The processor 1505 can also control sensor data capture parameters such as autofocus, auto-exposure, frame rates, etc. Processor 1505 may, in some embodiments, comprise a plurality of processors. Processor 1505 may also comprise an image signal processor (not shown) or a software implementation of a processor.

The input device 1580 may take on many forms depending on the implementation. In some implementations, the input device 1580 may be integrated with a display (e.g., display 1660 of FIG. 12) so as to form a touchscreen display. In other implementations, the input device 1580 may include separate keys or buttons on a device remote from the automotive safety system 200. In other implementations, the input device 1580 may be an input port. For example, the input device 1580 may provide for operative coupling of another device to the sensor device 1500. The sensor device 1500 may receive input from an attached keyboard or mouse via the input device 1580. For example, a user, OEM, or similar may program the sensor device 1500 via the input device 1580 with parameters for ensuring integrity of the automotive safety system 200 (e.g., the input signal 810b of FIG. 8B may be entered via input device 1580).

The sensor device 1500 may also comprise a communicator circuit 1545. The communicator circuit 1545 may be coupled to the processor 1505, which may be configured to control the communicator circuit 1545. The communicator circuit 1545 may be configured to pass information to and from the processor 1505 for performing the various functions of the sensor device 1500. For example, the communicator circuit 1545 is configured to enable the sensor device 1500 to communicate with the integrated circuit 1600 by establishing a communication link with the integrated circuit (e.g., communication link 210 or two-way communication links 805a and 805b of FIGS. 7, 8A, and 8B, respectively). The communication link may be made with any communication protocol (e.g., an ultra-wideband radio communications protocol, Wi-Fi communication, Bluetooth communication protocol, and the like), and configured to implement the message-based protocol in accordance with embodiments described herein. As another example, the communicator circuit 1545 is configured to enable the sensor device 1500 to communicate with a remote source (e.g., a user, OEM, the like) to facilitate receiving parameters for ensuring integrity of the automotive safety system 200 (e.g., receiving the input signal 810b of FIG. 8B).

Processor 1505 may be configured to write data to storage 1520, for example image data representing captured image frames 205 and baseline vehicle safety data frames 705. Storage 1520 may also store baseline vehicle safety data frames 705 received from the processor 1505 or an external source. In some embodiments baseline vehicle safety data frames may be prewritten into storage 1505 during manufacturing and testing of the sensor device 1500, may be written into storage periodically during the lifecycle of the sensor device 1500, or generated based on an adaptive calibration (e.g., as described throughout the present disclosure). The storage 1520 may also store operating parameters for ensuring integrity of the automotive safety system 200, for example, tolerance threshold time intervals, ASILs, FTTIs, frame rates, etc. These operating parameters may be preinstalled or received from external sources (e.g., as described above in connection to FIGS. 8A and 8B). For example, one or more operation parameters may be received from the input device 1580, or from the integrated circuit 1600 via a communication link, and subsequently stored in storage 1520. The storage 1520 may also store the message packet frame formats (e.g., FIGS. 10A-10F) for implementing the message-based protocol, which may be retrieved by the processor 1505 in accordance with embodiments of the message-based protocol as described herein (e.g., FIGS. 9A-9B).

While storage 1520 is represented schematically as a traditional disk device, storage 1520 may be configured as any storage media device. For example, the storage 1520 may include a disk drive, such as an optical disk drive or magneto-optical disk drive, or a solid state memory, such as a FLASH memory, RAM, ROM, and/or EEPROM. The storage 1520 can also include multiple memory units, and any one of the memory units may be configured to be within the sensor device 1500, or may be external to the sensor device 1500. For example, the storage 1520 may include a ROM memory containing system program instructions stored within the sensor device 1500. The storage 1520 may also include memory cards or high speed memories configured to store captured images which may be removable from the imaging device. The storage 1520 can also be external to sensor device 1500, and in one example sensor device 1500 may wirelessly transmit data to the storage 1520, for example over a network connection. In such embodiments, storage 1520 may be a server or other remote computing device.

As shown, the processor 1505 is connected to the memory 1530 and the working memory 1515. In the illustrated embodiment, the memory 1530 may be a computer-readable media and may store a baseline vehicle safety data frame determination module 1532, a baseline vehicle safety data frame control module 1534, a capture control module 1535, and an operating system module 1537. The modules of the memory 1530 include instructions that configure the processor 1505 to perform various functions and device management tasks as described throughout this application. Working memory 1515 may be used by processor 1505 to store a working set of processor instructions contained in the modules of memory. Alternatively, working memory 1515 may also be used by processor 1505 to store dynamic data created during the operation of sensor device 1500. In some embodiments, the working memory 1515 may also store the message packet frame formats (e.g., FIGS. 10A-10F) for implementing the message-based protocol, which may be retrieved by the processor 1505 based on instructions in one or more modules of the memory 1530 in accordance with embodiments of the message-based protocol as described herein (e.g., FIGS. 9A-9B).

The baseline vehicle safety data frame determination module 1532 may include instructions that configure the processor 1505 to determine the number or insertion interval of baseline vehicle safety data frames to be used for ensuring the integrity of the automotive safety system 200. For example, baseline vehicle safety data frame determination module 1532 may include instructions that call subroutines to configure the processor 1505 to perform the method described above in connection to FIG. 7. In one embodiment, baseline vehicle safety data frame determination module 1532 may include instructions that call subroutines to configure the processor 1505 to retrieve the configuration data or operating parameters (e.g., FIG. 6A) from storage 1520. In some embodiments, test frame determination module 532 may include instructions that call subroutines to configure the processor 505 to derive the tolerance threshold time interval from operation parameters stored in storage 520. In some embodiments, test frame determination module 1532 may include instructions that call subroutines to configure the processor 1505 to perform adaptive auto calibration, as described above in connection to FIGS. 4 and 8A-10F. The baseline vehicle safety data frame determination module 1532 may also include instructions that call subroutines to configure the processor 1505 to transmit and store data in the working memory 1515, or storage 1520, indicative the number or insertion interval of baseline vehicle safety data frames.

The baseline vehicle safety data frame control module 1534 may include instructions that configure the processor 1505 to provide the baseline vehicle safety data frames to the image sensor 1510. For example, baseline vehicle safety data frame control module 1534 may include instructions that call subroutines to configure the processor 1505 to retrieve one or more baseline vehicle safety data frame types from the storage 1520 or working memory 1515. The baseline vehicle safety data frame control module 1534 may also include instructions that call subroutines to configure the processor 1505 to insert or provide a selected baseline vehicle safety data frame between two sensor data frames as described above in connection to FIG. 7. For example, the baseline vehicle safety data frame control module 1534 may include instructions that call subroutines to configure the processor 1505 to retrieved the data indicative of the number or insertion interval of baseline vehicle safety data frames and insert a baseline vehicle safety data frame based on this data.

The capture control module 1535 may include instructions that configure the processor 1505 to control the overall data capture functions of the sensor device 1500. For example, capture control module 1535 may include instructions that call subroutines to configure the processor 1505 to capture image data of one or more image frames 205 of the environment using the sensor device 1500. In another example, capture control module 1535 may include instructions that call subroutines to configure the processor 1505 to capture non-image data of one or more sensor data frames 205 of the environment using the sensor device 1500.

The capture control module 1535 may also include instructions that configure the processor 1505 to transmit the sensor and baseline vehicle safety data to the integrated circuit 1600. For example, upon capturing the sensor data and generating baseline vehicle safety data, instructions in the capture control module 1535 may configure the processor 1505 to execute subroutines to store the image and baseline vehicle safety data in the working memory 1515 (or storage 1520), retrieve the data, and transmit the data via the communication circuit 1545. The sensor data may be stored sequentially upon capture (e.g., in order of capture or including an identifier indicative of the capture order), the baseline vehicle safety data inserted between sequential sensor data, and the data may be sent sequentially to the integrated circuit 1600.

Operating system module 1537 configures the processor 1505 to manage the working memory 1515 and the processing resources of sensor device 1500. For example, operating system module 1537 may include device drivers to manage hardware resources such as the image sensor 1510 and/or communication controller 1540. Therefore, in some embodiments, instructions contained in the processing modules discussed above may not interact with these hardware resources directly, but instead interact through standard subroutines or APIs located in operating system module 1537. Instructions within operating system module 1537 may interact directly with these hardware components. Operating system module 1537 may further configure the processor.

Although FIG. 11 depicts a sensor device 1500 having separate components such as a processor, imaging sensor, and memory, it is noted that these separate components may be combined in a variety of ways to achieve particular design objectives. For example, in an alternative embodiment, the memory components may be combined with processor components, for example, to save costs and/or to improve performance.

Additionally, although FIG. 11 illustrates two memory components, including memory 1530 comprising several modules and a separate memory component comprising a working memory 1515, one with skill in the art would recognize several embodiments utilizing different memory architectures are possible. For example, a design may utilize ROM or static RAM memory for the storage of processor instructions implementing the modules contained in memory 1530. The processor instructions may be loaded into RAM to facilitate execution by the processor 1505. For example, working memory 1515 may comprise RAM memory, with instructions loaded into working memory 1515 before execution by the processor 1505.

FIG. 12 illustrates a high-level schematic block diagram of an embodiment of an integrated circuit 1600 according to embodiments herein. The integrated circuit 1600 may be part of the automotive safety system 200 of FIG. 7, as described above. The integrated circuit 1600 comprises a set of components, including a signal processor (SP) 1620 in communication with the sensor device 1500 of FIG. 11. The SP 1620 may be in wired or wireless communication (e.g., via communication circuit 1545) with the sensor device 1500. The SP 1620 is also operatively connected to a working memory 1605, memory 1630, and device processor 1650. The device processor 1650 may be operatively coupled to memory 1630, storage 1610, communication circuit 1645, input device 1670, optional display 1660, and optional coder/decoder 1650, which is in turn in communication with optional speaker 1652 and microphone 1654. The memory 1630 stores several modules that store data values defining instructions to configure SP 1620 and/or device processor 1650 to perform functions of integrated circuit 1600, as will be described in more detail below.

The SP 1620 may be configured to perform various processing operations on received sensor and baseline vehicle safety data in order to execute processing techniques to generate processed sensor and processed baseline vehicle safety data. SP 1620 may be a general purpose processing unit or a processor specially designed for sensing and safety applications. Examples of SP implemented as an imaging signal processor for image processing operations include demosaicking, white balance, cross talk reduction, cropping, scaling (e.g., to a different resolution), image stitching, image format conversion, color interpolation, color processing, image filtering (e.g., spatial image filtering), lens artifact or defect correction, etc. Similar processing techniques may be implemented for non-image based sensing applications. SP 1620 may, in some embodiments, comprise a plurality of processors. SP 1620 may be one or more dedicated image signal processors or a software implementation of a processor.

The input device 1670 may take on many forms depending on the implementation. In some embodiments, the input device 1670 may be similar to input device 1580 of FIG. 11. For example, a user (or OEM or similar) may program the integrated circuit 1600 via the input device 1670 with parameters for testing the automotive safety system 200 (e.g., the input signal 810a of FIG. 8A may be entered via input device 1670).

The integrated circuit 1600 may also comprise a communicator circuit 1645. The communicator circuit 1645 may be coupled to the device processor 1650. The device processor 1650 may be configured to control the communicator circuit 1645 based on instructions in memory 1630. The communicator circuit 1645 is configured to pass information to and from the processor 1650 for performing the various functions of the integrated circuit 1600. For example, the communicator circuit 1645 is configured to enable the integrated circuit 1600 to communicate with the sensor device 1500 by establishing a communication link with the integrated circuit (e.g., communication link 210 or two-way communication links 805a and 805b of FIGS. 7, 8A, and 8B, respectively). The communication link may be made with any communication protocol (e.g., an ultra-wideband radio communications protocol, Wi-Fi communication, Bluetooth communication protocol, and the like), and configured to implement the message-based protocol in accordance with embodiments herein. As another example, the communicator circuit 1645 is configured to enable the integrated circuit 1600 to communicate with a remote source (e.g., a user, OEM, the like) to facilitate receiving parameters for ensuring integrity of the automotive safety system 200 (e.g., receiving the input signal 810a of FIG. 8A).

Device processor 1660 may write data to storage 1610, for example processed data received from the SP 1620. In some embodiments, device processor 1650 may access storage 1610 to retrieve reference baseline vehicle safety data (e.g., as described in connection to FIGS. 5-7). While storage 1610 is represented schematically as a traditional disk device, storage 1610 may be configured as any storage media device, for example, as described above in connection to storage 1520 of FIG. 11. The storage 1610 may also store operating parameters for ensuring integrity of the automotive safety system 200, for example, tolerance threshold time intervals, ASILs, FTTIs, frames rates, etc. These operating parameters may be preinstalled or received from external sources (e.g., as described above in connection to FIGS. 4A and 4B). For example, one or more operation parameters may be received from the input device 1670 or from the sensor device 1500 via a communication link and subsequently stored in storage 1610. The storage 1610 may also store the message packet frame formats (e.g., FIGS. 10A-10F) for implementing the message-based protocol, which may be retrieved by the device processor 1660 in accordance with embodiments of the message-based protocol as described herein (e.g., FIGS. 9A-9B).

As shown, the SP 1620 and device processor 1650 are connected to the memory 1630 and the working memory 1605. In the illustrated embodiment, the memory 1630 may be a computer-readable media, and may store a baseline vehicle safety frame determination module 1632, a data processing module 1634, a reference control module 1635, a verification module 1637, and an operating system module 1639. The modules of the memory 1630 include instructions that configure the SP 1620 or device processor 1650 to perform various functions and device management tasks as described throughout this application. Working memory 1605 may be used by SP 1620 or device processor 1650 to store a working set of processor instructions contained in the modules of memory. Alternatively, working memory 1605 may also be used by SP 1620 or device processor 1650 to store dynamic data created during the operation of integrated circuit 1600. In some embodiments, the working memory 1605 may also store the message packet frame formats (e.g., FIGS. 10A-10F) for implementing the message-based protocol, which may be retrieved by the device processor 1620 based on instructions in one or more modules of the memory 1630 in accordance with embodiments of the message-based protocol as described herein (e.g., FIGS. 9A-9B).

The baseline vehicle safety data frame determination module 1632 may include instructions that configure the device processor 1650 to determine the number or insertion interval of baseline vehicle safety data frames 705 to be used for testing the integrity of the automotive safety system 200. For example, baseline vehicle safety data frame determination module 1632 may include instructions that call subroutines to configure the device processor 1650 to perform the method described above in connection to FIG. 7. In one embodiment, baseline vehicle safety data frame determination module 1632 may include instructions that call subroutines to configure the device processor 1650 to retrieve the configuration or operating parameters (e.g., FIG. 6A) from storage 1610. In some embodiments, baseline vehicle safety data frame determination module 1632 may include instructions that call subroutines to configure the device processor 1650 to derive the tolerance threshold time interval from operation parameters stored in storage 1610. In some embodiments, baseline vehicle safety data frame determination module 1632 may include instructions that call subroutines to configure the device processor 1650 to perform adaptive auto-calibration, as described above in connection to FIGS. 4 and 8A-10F. The baseline vehicle safety data frame determination module 1632 may also include instructions that call subroutines to configure the device processor 1650 to transmit and store data in the working memory 1605 or storage 1610 indicative the number or insertion interval of baseline vehicle safety data frames.

The data processing module 1634 may include instructions that configure the SP 1620 to process data received from the sensor device 1500. In some embodiments, the data processing module 1634 may include instructions that call subroutines to configure the SP 1620 to process sequentially received sensor data for use in performing functions of the safety applications. For example, the SP 1620 may be configured to process the sensor data, which may be stored in the storage 1610 or working memory 1605 for use in executing decisions for ADAS or surround view systems. This processed sensor data may also be displayed to the user via optional display 1660. In some embodiments, the data processing module 1634 may include instructions that call subroutines to configure the SP 1620 to process sequentially received baseline vehicle safety data for use verifying that the automotive safety system 200 is operating as designed (e.g., FIGS. 5-7). In some implementations, the test data may not be used in making determinations in ADASs or surround view systems, or may not be displayed to the user via display 1660. The data processing module 1634 may also include instructions that configure the device processor 1650 to store the processed image and baseline vehicle safety data in storage 1610 or working memory 1605.

The verification module 1637 may include instructions that configure the device processor 1650 to retrieve reference baseline vehicle safety data. The verification module 1637 may include instructions that call subroutines to configure the device processor 1650 to access storage 1610 and/or working memory 1605 to retrieve reference baseline vehicle safety data stored therein. As described above in connection with FIG. 4-7, reference baseline vehicle safety data may be indicative of the expected or known results of the processed first baseline vehicle safety data based on a given baseline vehicle safety data frame 705. A plurality of referenced baseline vehicle safety data may be stored in the storage 1610 or working memory 1605, each corresponding to a given baseline vehicle safety data frame 705a through 705m, which may be the same baseline vehicle safety data frame or different between each set of reference baseline vehicle safety data. The reference baseline vehicle safety data may be preinstalled or stored in the memory components of the integrated circuit 1600, or may be stored in a remote memory device. In some embodiments, the reference baseline vehicle safety data may be periodically or asynchronously updated based on updating of baseline vehicle safety data frames 705 in the automotive safety system 200.

The verification module 1637 may also include instructions that configure the device processor 1650 to verify the integrity of the automotive safety system 200. For example, the verification module 1637 may include instructions that call subroutines to configure the device processor 1650 to retrieve processed first baseline vehicle safety data and compare the processed first baseline vehicle safety data with the reference baseline vehicle safety data to ensure that the automotive safety system 200 is operating as designed, as explained above in connection with FIG. 5-7. The verification module 1637 may include instructions that call subroutines to configure the device processor 1650 to perform the verification periodically and in real-time as the first baseline vehicle safety data is received from the sensor device 1500. For example, the verification module 1637 may include instructions that configure the device processor 1650 to retrieve a number or insertion interval of baseline vehicle safety frames 705 from storage 1610 or working memory 1605 for use in identifying which set of data is first baseline vehicle safety data, as opposed to sensor data. Thus, while SP 1620 separately processes the sensor and baseline vehicle safety data in the same manner, the device processor 1650 is able to properly utilize the sensor data for safety applications and the baseline vehicle safety data to test the automotive safety system 200.

Operating system module 1639 configures the device processor 1650 to manage the working memory 1605 and the processing resources of integrated circuit 161600. For example, operating system module 1639 may include device drivers to manage hardware resources, such as the communication circuit 1645 or optional component discussed below. Therefore, in some embodiments, instructions contained in the processing modules discussed above may not interact with these hardware resources directly, but instead interact through standard subroutines or APIs located in operating system component 1639. Instructions within operating system 1639 may interact directly with these hardware components. Operating system module 1639 may further configure the processor.

In some embodiments, device processor 1650 may be configured to control the display 1660 to display the captured sensor data frames 205 to a user. The display 1660 may be external to the automotive safety system 200. In some embodiments, the display 1660 may also be configured to provide a video stream to a user for use in safety applications. For example, the display 1660 may allow the user to view the environment surrounding the vehicle to prevent collisions or provide early warnings, as described above in connection to FIG. 1. The display may also be utilized to present warnings of identified failures and/or altered navigation plans as described above in connection to FIGS. 2A and 2B. The display 1660 may comprise an LCD, LED, or OLED screen, and may implement touch sensitive technologies.

Although FIG. 12 depicts an integrated circuit 1600 having separate components including an SP, device processor, and memory; it is noted that these separate components may be combined in a variety of ways to achieve particular design objectives. For example, in an alternative embodiment, the memory components may be combined with each of the processor components and the processor components may be integrated into a single processor component, for example to save cost and/or to improve performance.

Additionally, although FIG. 12 illustrates two memory components, including memory 1630 comprising several modules and a separate memory component comprising a working memory 1605, it is noted that several embodiments utilizing different memory architectures are possible. For example, a design may utilize ROM or static RAM memory for the storage of processor instructions implementing the modules contained in memory 1630. The processor instructions may be loaded into RAM to facilitate execution by the device processor 1650. For example, working memory 1605 may comprise RAM memory, with instructions loaded into working memory 1605 before execution by the device processor 1650.

In some embodiments, the automotive safety system 200 is an image-based SOC that integrates the various components of the automotive safety system 200 onto a single chip. In such embodiments, the sensor device 1500 and integrated circuit 1600 may be integrated into the single chip. For example, the separate components of the sensor device 1500 and integrated circuit 1600 may be combined in a variety of ways to achieve particular design objectives. For example, in an embodiment, the various memory components may be combined with each other and each of the processor components. Similarly, the processor 1505 may be combined with one or both of SP 1620 and device processor 1650.

Furthermore, in some SOC implementations, the automotive safety system 200 may include the CODEC 1640 and power supply 1680, coupled to the integrated circuit 1600. The display 1660, input device 1670, speaker 1652, microphone 1654, and power supply 1680 may be external to the integrated circuit 1600. However, each of these components may be coupled to a component of the automotive safety system 200, such as an interface or controller. One non-limiting advantage of the embodiments described herein is that there is minimal surface area (or die area) impact on the SOC, for example, because the methodologies described herein do not require additional components to test the automotive safety system 200. Accordingly, the die area of the SOC may be minimally affected.

Implementations disclosed herein provide systems, methods, and apparatus for testing an automotive safety system. Implementations disclosed herein also provide systems, methods, and apparatus for ensuring operational integrity of automotive safety systems for use in, for example, safety applications. It is noted that these embodiments may be implemented in hardware, software, firmware, or any combination thereof.

In some embodiments, the circuits, processes, and systems discussed above may be utilized in an automotive safety system. The automotive safety system may be a kind of electronic device used to wirelessly communicate with other electronic devices. Examples of devices that may include automotive safety systems as described herein include but are not limited to computers, circuits, integrated circuits, chip technologies, automobiles, cellular telephones, smart phones, Personal Digital Assistants (PDAs), e-readers, gaming systems, music players, netbooks, wireless modems, laptop computers, tablet devices, etc.

The automotive safety system may include one or more sensors, one or more signal processors, and a memory including instructions or modules for carrying out the process discussed above. The system may also have data, a processor loading instructions and/or data from memory, one or more communication interfaces, one or more input devices, one or more output devices such as a display device and a power source/interface. The automotive safety system may additionally include a transmitter and a receiver. The transmitter and receiver may be jointly referred to as a transceiver. The transceiver may be coupled to one or more antennas for transmitting and/or receiving wireless signals.

The automotive safety system may wirelessly connect to another electronic device or system (e.g., other components of an automobile). An automotive safety system may alternatively be referred to as an image-based ADAS, image capture device, acoustic-based ADAS, non-image-based ADAS etc. Examples of automotive safety system may be included as part of laptop or desktop computers, cellular phones, smart phones, wireless modems, e-readers, tablet devices, gaming systems, etc. Automotive safety systems may operate in accordance with one or more industry standards such as the ISO 26262. Thus, the general term “automotive safety systems” may include systems described with varying nomenclatures according to industry standards.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

It should be noted that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without author input or prompting, whether these features, elements or steps are included or are to be performed in any particular embodiment. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures, and techniques may be shown in detail to further explain the examples. Thus, the present invention is not intended to be limited to the implementations shown herein but is to be accorded the widest scope consistent with the principles and novel features disclosed herein.

What is claimed is:

1. A vehicle comprising:
an integrated circuit that includes a processor that is configured to:
support a message-based protocol between the integrated circuit and one or more sensor devices associated with the vehicle, and
send a sensor capability safety support message, which is part of the message-based protocol, to determine one or more sensor device capabilities of the one or more sensor devices, and
receive, in response to the sensor capability safety support message, identification data corresponding to the one or more sensor devices, from the one or more sensor devices; and
a memory configured to:
store a plurality of request data corresponding to a plurality of fields supported by the message-based protocol and associated with the integrated circuit and the one or more sensor devices capabilities, and
store the response, including the identification data, from the one or more sensor devices.

2. The vehicle of claim 1, wherein the integrated circuit is configured to periodically receive first baseline vehicle safety data associated with the identification data corresponding to the one or more sensor devices based on the message-based protocol and compare the periodically received first baseline vehicle safety data with second baseline vehicle safety data from the memory, and identify a failure if the periodically received first baseline vehicle safety data does not match the second baseline vehicle safety data from the memory.

3. The vehicle of claim 2, wherein the integrated circuit is configured to provide limited functionality to the vehicle if the failure is identified.

4. The vehicle of claim 3, wherein the limited functionality is an altered navigation plan.

5. The vehicle of claim 2, wherein at least one of the one or more sensor devices is a camera, and the first baseline vehicle safety data is a known image test frame.

6. The vehicle of claim 2, wherein at least one of the one or more sensor devices is a LIDAR sensor, and the first baseline vehicle safety data is a known LIDAR test frame.

7. The vehicle of claim 2, wherein at least one of the one or more sensor devices is a RADAR sensor, and the first baseline vehicle safety data is a known chirp frame.

8. The vehicle of claim 2, further comprising a display configured to present a representation of the identified failure.

9. The vehicle of claim 2, further comprising a first sensor device and a second sensor device, wherein the first sensor device is designated to operate as a primary sensor device associated with the vehicle, and the second sensor device is designated to operate as a fallback sensor device associated with the vehicle, and wherein the integrated circuit is configured to switch the designation of the first device as the primary sensor device to a fallback sensor device, and switch the designation of the second device as the fallback sensor device to a primary sensor device when the failure is identified.

10. The vehicle of claim 9, wherein the primary sensor devices and fallback sensor devices are directly or indirectly coupled to a processor that includes a primary perception unit and secondary perception unit, each perception unit detects a visual object or warning.

11. The vehicle of claim 1, wherein the integrated circuit is configured to:
send, in the sensor capability safety support message, a request query data in a query field of the plurality of fields, and
receive, a response including the identification data, from one of the one or more sensor devices associated with the vehicle that includes data responsive to the request query data supported by the one or more sensor devices associated with the vehicle.

12. The vehicle of claim 1, wherein the integrated circuit is configured to:
send, in the sensor capability safety support message, a request type of test frame data in a type of test frame data field included in the plurality of fields, and
receive, a response including type of test frame supported by the one or more sensor devices associated with the vehicle, from the one or more sensor devices associated with the vehicle.

13. The vehicle of claim 1, wherein the integrated circuit is configured to:
send, in the sensor capability safety support message, a request including what frame rate data in a frame rate field included in the plurality of fields, and
receive, a response including what frame rate supported by the one or more sensor devices associated with the vehicle, from the one or more sensor devices associated with the vehicle.

14. The vehicle of claim 1, wherein the integrated circuit is configured to:
send, in the sensor capability safety support message, a request including what calibration data in a calibration type field included in the plurality of fields, and
receive, a response including what calibration type is supported by the one or more sensor devices associated with the vehicle, from the one or more sensor devices associated with the vehicle.

15. The vehicle of claim 1, wherein the identification data associated with one or more sensor devices is acknowledgment data that confirms one or more capabilities are supported from the one or more sensor devices.

16. The vehicle of claim 1, wherein the identification data associated with one or more sensor devices is acknowledgment data that confirms that one or more capabilities are not supported from the one or more sensor devices.

17. The vehicle of claim 1, wherein the integrated circuit is configured to read operational data, including baseline vehicle safety data from the memory, and send the operational data, including the baseline vehicle safety data to the one or more sensor devices that confirm that one or more capabilities are supported from the one or more sensor devices.

18. A method comprising:
sending a sensor capability safety support message to determine one or more sensor device capabilities of the one or more sensor devices, the sensor capability safety support message is part of a message-based protocol between an integrated circuit and one or more sensor devices associated with a vehicle;
receiving, in response to the sensor capability safety support message, identification data corresponding to the one or more sensor devices, from the one or more sensor devices;
storing a plurality of request data corresponding with a plurality of fields supported by the message-based protocol associated with the integrated circuit and the one or more sensor devices capabilities; and
storing the response, including the identification data, from the one or more sensor devices.

19. The method of claim 18, further comprising:
periodically receiving first baseline vehicle safety data associated with the identification data corresponding to the one or more sensor devices based on the message-based protocol;
comparing the periodically received first baseline vehicle safety data with second baseline vehicle safety data from the memory; and
identifying a failure if the periodically received first baseline vehicle safety data does not match the second baseline vehicle safety data from the memory.

20. The method of claim 19, wherein the one or more sensor devices comprises a first sensor device designated to operate as a primary sensor device associated with the vehicle and a second sensor device designated to operate as a fallback sensor device associated with the vehicle, wherein the method further comprises:
switching a designation of a first device as a primary sensor device to a fallback sensor device; and
switching a designation of a second device as a fallback sensor device to a primary sensor device when the failure is identified.

21. A system for sensing an environment surrounding a vehicle, the system comprising:
a source component that includes a processor configured to:
support a message-based protocol between the source component and a target component associated with the vehicle, and
send a capability safety support message, which is part of the message-based protocol, to determine one or more capabilities of the target component, and
receive, in response to the capability safety support message, identification data corresponding to the target component, from the target component; and
a memory configured to:
store a plurality of request data corresponding to a plurality of fields supported by the message-based protocol and associated with the source component and the one or more capabilities of the target component, and
store the response, including the identification data, from the target component.

22. The system of claim 21, wherein the source component is an integrated circuit and the target component is one or more sensor devices.

23. The system of claim 21, wherein the at least one source component is one or more sensor devices and the target component is an integrated circuit.

24. The system of claim 21, wherein one of the source and target component is configured to periodically receive first baseline vehicle safety data associated with the identification data corresponding to the target component based on the message-based protocol and compare the periodically received first baseline vehicle safety data with second baseline vehicle safety data from the memory, and identify a failure if the periodically received first baseline vehicle safety data does not match the second baseline vehicle safety data from the memory.

25. The system of claim 24, wherein one of the source and target component is configured to provide limited functionality to the vehicle if the failure is identified.

26. The system of claim 24, further comprising a first sensor device and a second sensor device, wherein the first sensor device is designated to operate as primary sensor device associated with the vehicle, and the second sensor device is designated to operate as a fallback sensor device associated with the vehicle, and wherein one of the source and target components is configured to switch the designation of the first device as the primary sensor device to a fallback sensor device, and switch the designation of the second device as the fallback sensor device to a primary sensor device when the failure is identified.

27. The system of claim 21, wherein the source component is configured to:
send, in the capability safety support message, a request query data in a query field of the plurality of fields, and
receive, a response including the identification data, from the target component associated with the vehicle that includes data responsive to the request query data supported by the target component associated with the vehicle.

28. A non-transitory computer readable medium comprising instructions that when executed cause a processor to perform a method comprising:
sending a capability safety support message to determine one or more capabilities of at least one target component, the capability safety support message is part of a message-based protocol between at least one source component and the at least one target component;
receiving, in response to the capability safety support message, identification data corresponding to the at least one target component, from the at least one target component;
storing a plurality of request data corresponding with a plurality of fields supported by the message-based protocol associated with the at least one source component and the one or more capabilities of the at least one target component; and
storing the response, including the identification data, from the at least one target component.

29. The non-transitory computer readable medium of claim 28, wherein the at least one source component is an integrated circuit and the at least one target component is a sensor device.

30. The non-transitory computer readable medium of claim 28, wherein the at least one source component is a sensor device and the at least one target component is an integrated circuit.
